(19) United States
(12) Patent Application Publication
(10) Pub. No.: US 2013/0083400 A1
(43) Pub. Date: Apr. 4, 2013

(54) WAVELENGTH VARIABLE INTERFERENCE FILTER, OPTICAL FILTER DEVICE, OPTICAL MODULE, ELECTRONIC APPARATUS, AND METHOD OF MANUFACTURING THE WAVELENGTH VARIABLE INTERFERENCE FILTER

(71) Applicant: SEIKO EPSON CORPORATION, Tokyo (JP)

(72) Inventors: Teruyuki Nishimura, Matsumoto (JP); Yasushi Matsuno, Matsumoto (JP)

(73) Assignee: SEIKO EPSON CORPORATION, Tokyo (JP)

(21) Appl. No.: 13/630,058

(22) Filed: Sep. 28, 2012

(30) Foreign Application Priority Data
Sep. 29, 2011 (JP) 2011-215597

(51) Int. Cl. G02B 5/28; B32B 37/10

(52) U.S. Cl. 359/578; 156/182

(57) ABSTRACT

A wavelength variable interference filter includes a fixed substrate including a fixed reflective film, a movable substrate including a movable reflective film, and a bonding section configured to bond the fixed substrate and the movable substrate. The movable substrate includes a movable section, a holding section, and a substrate outer circumferential section. The holding section includes a flat section having a uniform thickness dimension and a curved surface section provided on the outer circumferential side of the flat section, a thickness dimension of the curved surface section increasing toward the substrate outer circumferential section. The bonding section is provided in an outer circumferential region extending along substrate outer circumferential edges on surfaces opposed to each other of the fixed substrate and the movable substrate. The inner circumferential edge of the bonding section is provided further on the inner side than the outer circumferential edge of the curved surface section.

### BACKGROUND

1. Technical Field

The present invention relates to a wavelength variable interference filter for extracting light having specific wavelength from incident light, an optical filter device, an optical module, an electronic apparatus, and a method of manufacturing the wavelength variable interference filter.

2. Related Art

In the past, there is known a wavelength variable interference filter in which reflective films are respectively arranged to be opposed to each other via a predetermined gap on surfaces opposed to each other of a pair of substrates (see, for example, JP-A-2010-8644 (Patent Literature 1)).

In an optical filter (the wavelength variable interference filter) described in Patent Literature 1, a first substrate and a second substrate are bonded and mirrors (reflective films) are respectively provided on surfaces opposed to each other of the substrates. In the wavelength variable interference filter, a groove section having an annular shape in plan view and a movable section, which is a portion surrounded by the groove section, are provided on the first substrate. In such a wavelength variable interference filter, it is possible to advance and retract the movable section with respect to the second substrate by bending the groove section. In the wavelength variable interference filter, the groove section is formed such that the annular outer circumferential edge of the groove section is present further on the inner side (the movable section side) than a bonding section of the first substrate and the second substrate.

The wavelength variable interference filter is manufactured as explained below. After applying predetermining machining to the first substrate and the second substrate to determine a shape, reflective films and electrodes are formed on the substrates. Thereafter, the substrates are laid one on top of the other, pressurized with a predetermined load, and fixed (pressurized and bonded) by joining, bonding, or the like to manufacture the wavelength variable interference filter.

When the groove section is formed on the first substrate formed by a glass substrate or the like, usually, wet etching is carried out. In the wet etching, after a mask layer opened in a forming position of the groove section is formed on the first substrate, the substrate is etched by an etching gas of hydrofluoric acid or the like. In such wet etching, the bottom surface of the groove section can be formed in a substantially plane shape to correspond to the opening portion of the mask layer. However, a curved surface is formed around the bottom surface of the groove section by side etching.

In Patent Literature 1, the groove section is formed such that the outer circumferential edge of the groove section is located further on the inner side than the bonding section of the first substrate and the second substrate. In the case of such a configuration, when the first substrate and the second substrate are pressurized and bonded, moment force acts along the curved surface or an inclined plane of the groove section and the groove section bends to the second substrate side. In this case, depending on the magnitude of a load, the reflective films come into contact with each other.

### SUMMARY

An advantage of some aspects of the invention is to provide a wavelength variable interference filter in which a bend of a substrate can be suppressed, an optical filter device, an optical module, an electronic apparatus, and a method of manufacturing the wavelength variable interference filter. An aspect of the invention is directed to a wavelength variable interference filter including: a first substrate; a second substrate opposed to the first substrate; a first reflective film provided on the first substrate; a second reflective film provided on the second substrate and opposed to the first reflective film via an inter-reflective film gap; and a bonding section configured to bond the first substrate and the second substrate. The second substrate includes: a movable section on which the second reflective film is provided; a holding section provided on the outer circumferential side of the movable section in plan view of the second substrate viewed from the substrate thickness direction and configured to hold the movable section to be capable of advancing and retracing with respect to the first substrate; and a substrate outer circumferential section provided on the outer circumferential side of the holding section in the plan view. The holding section includes: a flat section having a uniform thickness dimension, which is smaller than thickness dimensions of the movable section and the substrate outer circumferential section; and a holding outer circumferential section provided on the outer circumferential side of the flat section in the plan view, a thickness dimension of the holding outer circumferential section increasing from the flat section toward the substrate outer circumferential section. The bonding section is provided in an outer circumferential region extending along substrate outer circumferential edges on surfaces opposed to each other of the first substrate and the second substrate in plan view of the first substrate and the second substrate viewed from the substrate thickness direction. The inner circumferential edge of the bonding section is provided further on the inner side than the outer circumferential edge of the holding outer circumferential section.

The holding outer circumferential section is formed such that the upper surface is a curved surface or an inclined plane from the flat section to the substrate outer circumferential section. Specifically, when the holding section is formed on the second substrate by etching, the shape of the holding outer circumferential surface is different depending on a material of the holding section and an etching method. For example, when isotropic etching is carried out by wet etching, the holding outer circumferential section having an etching surface formed in a curved line in sectional view is formed because of the influence of side etching. On the other hand, for example, when a base material of silicon or the like is subjected to anisotropic etching with KOH or the like, the holding outer circumferential section having an etching surface formed in a straight line inclining with respect to the substrate thickness direction in sectional view is formed. In plan view of the wavelength variable interference filter (the first substrate, the second substrate and the bonding section) viewed from the substrate thickness direction (hereinafter sometimes referred to as filter plan view), the inner circumferential edge of the bonding section for bonding the first substrate and the second substrate is located further on the inner side than the outer circumferential edge of the holding outer circumferential section in the holding section.

A part of the holding outer circumferential section overlaps the bonding section.

With such a configuration, a bend of the second substrate can be reduced.

During manufacturing of the wavelength variable interference filter, it is necessary to bond the first substrate and the second substrate. In order to maintain the first substrate and the second substrate in parallel and obtain high bonding strength, during bonding, it is necessary to pressurize the first substrate and the second substrate in a direction in which the substrates are brought close to each other. In this case, even if the holding outer circumferential section of the second substrate is not directly pressurized, if a load is applied to the substrate outer circumferential section, moment force of bending to the first substrate side is generated in the holding outer circumferential section of the holding section because of the influence of the load. In this aspect of the invention, as explained above, a part of the holding outer circumferential section and the bonding section overlap in the filter plan view. In the case, in a portion where the holding outer circumferential section and the bonding section overlap, even if moment force is generated, the force can be received and a bend does not occur in the holding outer circumferential section because the bonding section is present right under the holding outer circumferential section. Therefore, a bend of the second substrate to the first substrate side can be prevented. During manufacturing, it is possible to prevent contact of the reflective films due to the load application. Therefore, it is possible to maintain a reflection characteristic of the reflective films.

In the wavelength variable interference filter of the aspect of the invention, it is preferred that the inner circumferential edge of the bonding section is provided further on the outer side than the inner circumferential edge of the flat section in plan view of the first substrate and the second substrate viewed from the substrate thickness direction.

The movable section of the second substrate is enabled to advance and retract with respect to the first substrate by the holding section. In other words, by bending the flat section having the thickness dimension smaller than that of the movable section, it is possible to displace the movable section to the first substrate side without changing the shape of the movable section. Therefore, if the entire flat section is bonded to the bonding section, it is difficult to bend the movable section.

In the configuration described above, the inner circumferential edge of the bonding section is provided further on the outer side than the inner circumferential edge of the flat section. With such a configuration, when the inter-reflective film gap is changed, it is possible to displace the movable section to the first substrate side by bending a region of the flat section not overlapping the bonding section.

In the wavelength variable interference filter of the aspect of the invention, it is preferred that the inner circumferential edge of the bonding section is present in a position overlapping the holding outer circumferential section in plan view of the first substrate and the second substrate viewed from the substrate thickness direction.

The bonding section does not overlap the flat section of the holding section. In other words, when the inter-reflective film gap is changed, it is possible to displace the movable section to the first substrate side by bending the entire flat section. With such a configuration, in the filter plan view, it is easy to bend the flat section compared with a configuration in which a part of the flat section overlaps the bonding section. Further, it is possible to suppress force of bending the holding outer circumferential section to the first substrate side, which is generated during the pressurizing and bonding, compared with a configuration in which the inner circumferential edge of the bonding section and the outer circumferential edge of the holding outer circumferential section are aligned and a configuration in which the inner circumferential edge of the bonding section is present further on the outer side than the outer circumferential edge of the holding outer circumferential section. Therefore, it is possible to suppress the inclination of the second substrate.

In the wavelength variable interference filter of the aspect of the invention, it is preferred that the inner circumferential edge of the bonding section is present in a boundary position of the flat section and the holding outer circumferential section in plan view of the first substrate and the second substrate viewed from the substrate thickness direction.

The bonding section does not overlap the flat section of the holding section in the filter plan view. Therefore, as explained above, when the inter-reflective film gap is changed, it is easy to bend the flat section and it is possible to easily carry out gap adjustment. In addition, the entire holding outer circumferential section overlaps the bonding section in the filter plan view. Therefore, when the first substrate and the second substrate are pressurized and bonded, even if moment force is generated in the holding outer circumferential section, it is possible to prevent, with the bonding section, a bend due to the moment force and surely prevent a bend of the second substrate.

In the wavelength variable interference filter of the aspect of the invention, it is preferred that the first substrate includes a concave groove section formed on a surface opposed to the second substrate. The bonding section is provided over an entire outer circumferential side region of the concave groove section on the surface of the first substrate opposed to the second substrate.

The concave groove section is provided on the first substrate and the inter-reflective film gap between the first reflective film and the second reflective film is formed by the concave groove section. In such a configuration, the bonding section may be provided in a part of the outer circumferential side region of the concave groove section of the first substrate. However, if an area of the bonding section is small, bonding strength of the first substrate and the second substrate cannot be sufficiently increased. In the configuration described above, since the bonding section is formed over the entire outer circumferential side region of the concave groove section, it is possible to obtain sufficient bonding strength.

Another aspect of the invention is directed to an optical filter device including: a wavelength variable interference filter including a first substrate, a second substrate opposed to the first substrate, a first reflective film provided on the first substrate, a second reflective film provided on the second substrate and opposed to the first reflective film via an inter-reflective film gap, and a bonding section configured to bond the first substrate and the second substrate; and a housing configured to house the wavelength variable interference filter. The second substrate includes: a movable section on which the second reflective film is provided; a holding section provided on the outer circumferential side of the movable section in plan view of the second substrate viewed from the substrate thickness direction and configured to hold the movable section to be capable of advancing and retracing with respect to the first substrate; and a substrate outer circumferential section provided on the outer circumferential side of the holding section in the plan view. The holding section includes: a flat section having a uniform thickness dimension, which is smaller than thickness dimensions of the movable section and the substrate outer circumferential section; and a holding outer circumferential section provided on the outer circumferential side of the flat section in the plan view of the second substrate viewed from the substrate thickness direction, a thickness dimension of the holding outer circumferential section increasing from the flat section toward the substrate outer circumferential section. The bonding section is provided in an outer circumferential region extending along substrate outer circumferential edges on surfaces opposed to each other of the first substrate and the second substrate in the plan view of the first substrate and the second substrate viewed from the substrate thickness direction. The inner circumferential edge of the bonding section is provided further on the inner side than the outer circumferential edge of the holding outer circumferential section.

As in the aspect of the invention explained above, the inner circumferential edge of the bonding section is located further on the inner side than the outer circumferential edge of the holding outer circumferential section in the holding section in the filter plan view. Therefore, it is possible to eliminate moment of bending to the first substrate side in a portion of the holding outer circumferential section overlapping the bonding section and reduce a bend of the second substrate. Further, during manufacturing, it is possible to prevent contact of the reflective films due to load application. Therefore, it is possible to maintain a reflection characteristic of the reflective films.

Since the wavelength variable interference filter is housed in the housing, impact from the outside is less easily transmitted to the wavelength variable interference filter. Therefore, it is possible to prevent breakage of the wavelength variable interference filter.

Still another aspect of the invention is directed to an optical module including: a first substrate; a second substrate opposed to the first substrate; a first reflective film provided on the first substrate; a second reflective film provided on the second substrate and opposed to the first reflective film via an inter-reflective film gap; a bonding section configured to bond the first substrate and the second substrate; and a detecting section configured to detect light extracted by the first reflective film and the second reflective film. The second substrate includes: a movable section on which the second reflective film is provided; a holding section provided on the outer circumferential side of the movable section in plan view of the second substrate viewed from the substrate thickness direction and configured to hold the movable section to be capable of advancing and retracing with respect to the first substrate; and a substrate outer circumferential section provided on the outer circumferential side of the holding section in the plan view. The holding section includes: a flat section having a uniform thickness dimension, which is smaller than thickness dimensions of the movable section and the substrate outer circumferential section; and a holding outer circumferential section provided on the outer circumferential side of the flat section in the plan view of the second substrate viewed from the substrate thickness direction, a thickness dimension of the holding outer circumferential section increasing from the flat section toward the substrate outer circumferential section. The bonding section is provided in an outer circumferential region extending along substrate outer circumferential edges on surfaces opposed to each other of the first substrate and the second substrate in the plan view of the first substrate and the second substrate viewed from the substrate thickness direction. The inner circumferential edge of the bonding section is provided further on the inner side than the outer circumferential edge of the holding outer circumferential section.

As in the aspects of the invention explained above, the inner circumferential edge of the bonding section is located further on the inner side than the outer circumferential edge of the holding outer circumferential section in the holding section in the filter plan view. Therefore, it is possible to eliminate moment of bending to the first substrate side in a portion of the holding outer circumferential section overlapping the bonding section and reduce a bend of the second substrate. Further, during manufacturing, it is possible to prevent contact of the reflective films due to load application. Therefore, it is possible to maintain a reflection characteristic of the reflective films.

In addition, since the second substrate does not bend as explained above, it is possible to accurately maintain a parallel relation between the first reflective film and the second reflective film and extract light having desired wavelength at high resolution. Therefore, by detecting such light with the detecting section, it is possible to accurately measure a light amount of the light having the desired wavelength extracted by the first reflective film and the second reflective film.

Yet another aspect of the invention is directed to an electronic apparatus including: a first substrate; a second substrate opposed to the first substrate; a first reflective film provided on the first substrate; a second reflective film provided on the second substrate and opposed to the first reflective film via an inter-reflective film gap; and a bonding section configured to bond the first substrate and the second substrate. The second substrate includes: a movable section on which the second reflective film is provided; a holding section provided on the outer circumferential side of the movable section in plan view of the second substrate viewed from the substrate thickness direction and configured to hold the movable section to be capable of advancing and retracing with respect to the first substrate; and a substrate outer circumferential section provided on the outer circumferential side of the holding section in the plan view. The holding section includes: a flat section having a uniform thickness dimension, which is smaller than thickness dimensions of the movable section and the substrate outer circumferential section; and a holding outer circumferential section provided on the outer circumferential side of the flat section in the plan view of the second substrate viewed from the substrate thickness direction, a thickness dimension of the holding outer circumferential section increasing from the flat section toward the substrate outer circumferential section. The bonding section is provided in an outer circumferential region extending along substrate outer circumferential edges on surfaces opposed to each other of the first substrate and the second substrate in the plan view of the first substrate and the second substrate viewed from the substrate thickness direction. The inner circumferential edge of the bonding section is provided further on the inner side than the outer circumferential edge of the holding outer circumferential section.

As in the aspects of the invention explained above, the inner circumferential edge of the bonding section is located further on the inner side than the outer circumferential edge of the holding outer circumferential section in the holding section in the filter plan view. Therefore, it is possible to eliminate moment of bending to the first substrate side in a portion of the holding outer circumferential section overlapping the bonding section and reduce a bend of the second substrate. Further, during manufacturing, it is possible to prevent contact of the reflective films due to load application. Therefore, it is possible to maintain a reflection characteristic of the reflective films.

In addition, since the second substrate does not bend, it is possible to accurately maintain a parallel relation between the first reflective film and the second reflective film and extract light having desired wavelength at high resolution.

Therefore, in the electronic apparatus, when light having target wavelength extracted through light interference by the first reflective film and the second reflective film is detected and various kinds of processing is carried out on the basis of an amount of the light, it is possible to carry out the various kinds of processing on the basis of an accurate light amount and improve processing accuracy.

Still yet another aspect of the invention is directed to a method of manufacturing a wavelength variable interference filter including: a first substrate; a second substrate opposed to the first substrate; a first reflective film provided on the first substrate; a second reflective film provided on the second substrate and opposed to the first reflective film via an inter-reflective film gap; and a bonding section configured to bond the first substrate and the second substrate, the second substrate including: a movable section on which the second reflective film is provided; a holding section provided on the outer circumferential side of the movable section in plan view of the second substrate viewed from the substrate thickness direction and configured to hold the movable section to be capable of advancing and retracing with respect to the first substrate; and a substrate outer circumferential section provided on the outer circumferential side of the holding section in the plan view, the method including: machining the first substrate to form the first reflective film on the first substrate; machining the second substrate to form the second reflective film on the second substrate; and bonding the first substrate and the second substrate. The forming the second reflective film includes forming, with etching, the holding section including: a flat section having a uniform thickness dimension, which is smaller than thickness dimensions of the movable section and the substrate outer circumferential section; and a holding outer circumferential section provided on the outer circumferential side of the flat section in the plan view of the second substrate viewed from the substrate thickness direction, a thickness dimension of the holding outer circumferential section increasing from the flat section toward the substrate outer circumferential section, and the outer circumferential edge of the holding outer circumferential section being located on the outer side of the inner circumferential edge of the bonding section. The bonding the first substrate and the second substrate includes performing alignment adjustment to locate the inner circumferential edge of the bonding section further on the inner side than the outer circumferential edge of the holding outer circumferential section in plan view of the first substrate and the second substrate viewed from the substrate thickness direction and then pressurizing and bonding the first substrate and the second substrate via the bonding section. In the forming the second reflective film, the second substrate is etched to form the holding section such that the outer circumferential edge of the holding outer circumferential section of the holding section is further on the outer side than the inner circumferential edge of the bonding section. In the bonding section, after the alignment adjustment is performed such that the outer circumferential edge of the holding outer circumferential section of the holding section is on the outer side of the inner circumferential edge of the bonding section, the first substrate and the second substrate are bonded by pressurizing and bonding. By carrying out such pressurizing and bonding, it is possible to firmly bond the first substrate and the second substrate. In the pressurizing and bonding, a load is applied in a direction in which in bonding places (bonding sections) of the first substrate and the second substrate are bonded to each other. Therefore, moment force of bending toward the first substrate is generated in the holding outer circumferential section of the holding section. In this aspect of the invention, the outer circumferential edge of the holding outer circumferential section is located further on the outer side than the inner circumferential edge of the bonding section. A part of the holding outer circumferential section and the bonding section overlap in the filter plan view. Therefore, even if the holding outer circumferential section overlapping the bonding section in the filter plan view receives moment force, the holding outer circumferential section does not bend to the first substrate side because the bonding section is present right under the holding outer circumferential section. Consequently, it is possible to reduce a bend of the second substrate during bonding and prevent contact of the reflective films.

### BRIEF DESCRIPTION OF THE DRAWINGS

The invention will be described with reference to the accompanying drawings, wherein like numbers reference like elements.

FIG. 1 is a block diagram showing a schematic configuration of a colorimetric apparatus according to a first embodiment of the invention.

FIG. 2 is a plan view showing a schematic configuration of a wavelength variable interference filter according to the first embodiment.

FIG. 3 is a sectional view showing a schematic configuration of the wavelength variable interference filter according to the first embodiment.

FIG. 4 is a plan view of a fixed substrate viewed from a movable substrate side in the first embodiment.

FIG. 5 is a plan view of the movable substrate viewed from the fixed substrate side in the first embodiment.

FIGS. 6A to 6F are diagrams showing a manufacturing process of the fixed substrate in the first embodiment.

FIGS. 7A to 7E are diagrams showing a manufacturing process of the movable substrate in the first embodiment.

FIG. 8 is a diagram showing a bonding process in the first embodiment.

FIGS. 9A and 9B are diagrams showing how force is applied during pressurizing and bonding in a bonding process for a wavelength variable interference filter in the past.

FIGS. 10A and 10B are diagrams showing how force is applied during pressurizing and bonding in a bonding process for the wavelength variable interference filter according to the first embodiment.

FIG. 11 is a sectional view showing a schematic configuration of an optical filter device according to a second embodiment.

FIGS. 12A and 12B are sectional views showing a schematic configuration of a wavelength variable interference filter according to another embodiment.

FIG. 13 is a schematic diagram showing a gas detecting apparatus including a wavelength variable interference filter in another embodiment.

FIG. 14 is a block diagram showing the configuration of a control system of the gas detecting apparatus shown in FIG. 13.

FIG. 15 is a diagram showing a schematic configuration of a food analyzing apparatus including a wavelength variable interference filter in another embodiment.

FIG. 16 is a schematic diagram showing a schematic configuration of a spectrum camera in another embodiment.

### DESCRIPTION OF EXEMPLARY EMBODIMENTS

### First Embodiment

A first embodiment of the invention is explained below with reference to the accompanying drawings.

### 1. Schematic Configuration of a Colorimetric Apparatus

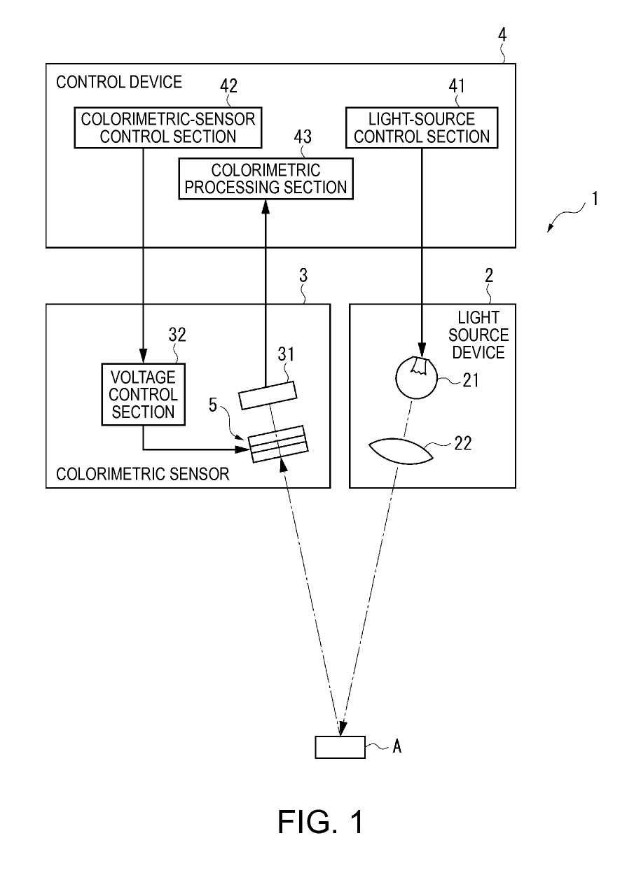

FIG. 1 is a block diagram of a schematic configuration of a colorimetric apparatus 1 (an electronic apparatus) according to this embodiment.

The colorimetric apparatus 1 includes, as shown in FIG. 1, a light source device 2 that emits light to an inspection target A, a colorimetric sensor 3 (an optical module), and a control device 4 that controls an overall operation of the colorimetric apparatus 1. The colorimetric apparatus 1 is an apparatus that reflects the light emitted from the light source device 2 on the inspection target A, receives reflected inspection target light in the colorimetric sensor 3, and analyzes and measures the chromaticity of the inspection target light, i.e., a color of the inspection target A on the basis of a detection signal output from the colorimetric sensor 3.

### 2. Configuration of the Light Source Device

The light source device 2 includes alight source 21 and plural lenses 22 (only one is shown in FIG. 1). The light source device 2 emits white light to the inspection target A. The plural lenses 22 may include a collimator lens. In this case, the light source device 2 converts the white light emitted from the light source 21 into parallel light using the collimator lens and emits the parallel light to the inspection target A from a not-shown projection lens. In this embodiment, the colorimetric apparatus 1 including the light source device 2 is illustrated. However, for example, when the inspection target A is a light emitting member such as a liquid crystal panel, the light source device 2 does not have to be provided.

### 3. Configuration of the Colorimetric Sensor

The colorimetric sensor 3 includes, as shown in FIG. 1, a wavelength variable interference filter 5, a detecting section 31 that receives light transmitted through the wavelength variable interference filter 5, and a voltage control section 32 that changes the wavelength of the light transmitted through the wavelength variable interference filter 5. The colorimetric sensor 3 includes, in a position opposed to the wavelength variable interference filter 5, a not-shown incident optical lens that guides the reflected light (the inspection target light) reflected by the inspection target A to the inside. The colorimetric sensor 3 splits, with the wavelength variable interference filter 5, light having predetermined wavelength in the inspection target light made incident from the incident optical lens and receives the split light in the detecting section 31.

The detecting section 31 includes plural photoelectric conversion elements. The detecting section 31 generates an electric signal corresponding to a received light amount. The detecting section 31 is connected to the control device 4. The detecting section 31 outputs the generated electric signal to the control device 4 as a light reception signal.

### 3-1. Configuration of the Wavelength Variable Interference Filter

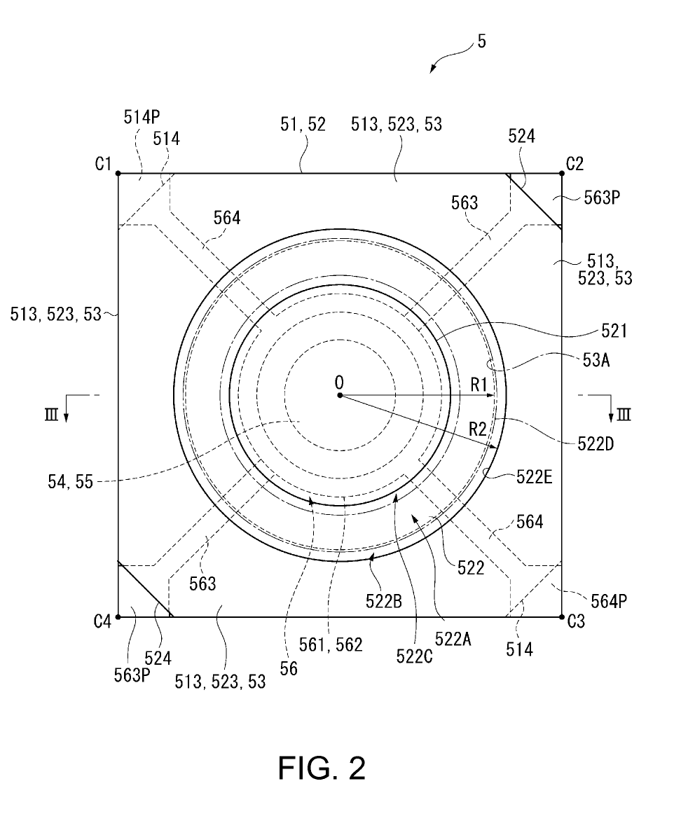

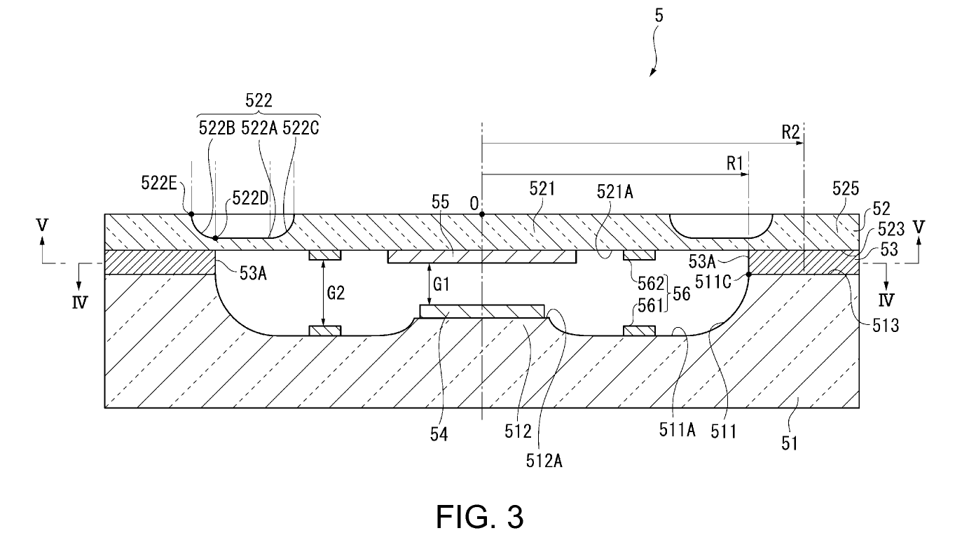

FIG. 2 is a plan view showing a schematic configuration of the wavelength variable interference filter 5. FIG. 3 is a sectional view showing a schematic configuration of the wavelength variable interference filter 5 taken along line shown in FIG. 2.

As shown in FIG. 2, the wavelength variable interference filter 5 is a tabular optical member having, for example, a plane square shape. The wavelength variable interference filter 5 includes, as shown in FIG. 3, a fixed substrate 51, which is the first substrate in the embodiment of the invention, and a movable substrate 52, which is the second substrate in the embodiment of the invention. Each of the fixed substrate 51 and the movable substrate 52 is formed of any one of various glasses such as soda glass, crystalline glass, quartz glass, lead glass, potassium glass, borosilicate glass, and no-alkali glass, quartz, and the like. A first bonding section 513 of the fixed substrate 51 and a second bonding section 523 of the movable substrate are pressurized and bonded by a bonding film 53 (a bonding section) formed of a plasma polymer film or the like containing, for example, siloxane as a main component, whereby the fixed substrate 51 and the movable substrate 52 are integrally formed.

A fixed reflective film 54, which forms the first reflective film in the embodiment of the invention, is provided on the fixed substrate 51. A movable reflective film 55, which forms the second reflective film in the embodiment of the invention, is provided on the movable substrate 52. The fixed reflective film 54 and the movable reflective film 55 are arranged to be opposed to each other via an inter-reflective film gap G1. In the wavelength variable interference filter 5, an electrostatic actuator 56 used for adjusting the dimension of the inter-reflective film gap G1 between the fixed reflective film 54 and the movable reflective film 55 is provided. The electrostatic actuator 56 includes a fixed electrode 561, which forms the first electrode in the embodiment of the invention, provided on the fixed substrate 51 and a movable electrode 562, which forms the second electrode in the embodiment of the invention, provided on the movable substrate 52. The electrodes 561 and 562 are opposed to each other via an inter-electrode gap G2 (G2>G1). The electrodes 561 and 562 may be respectively directly provided on the substrate surfaces of the fixed substrate 51 and the movable substrate 52 or may be provided via other film members.

In plan view shown in FIG. 2 of the wavelength variable interference filter 5 viewed from the substrate thickness direction of the fixed substrate 51 (the movable substrate 52), a plane center point O of the fixed substrate 51 and the movable substrate 52 is aligned with a center point of the fixed reflective film 54 and the movable reflective film 55 and is aligned with a center point of a movable section 521 explained below. In the following explanation, plan view of the wavelength variable interference filter 5 viewed from the substrate thickness direction of the fixed substrate 51 or the movable substrate 52, i.e., plan view of the wavelength variable interference filter 5 viewed from the laminating direction of the fixed substrate 51, the bonding film 53, and the movable substrate 52 is referred to as filter plan view.

### 3-1-1. Configuration of the Fixed Substrate

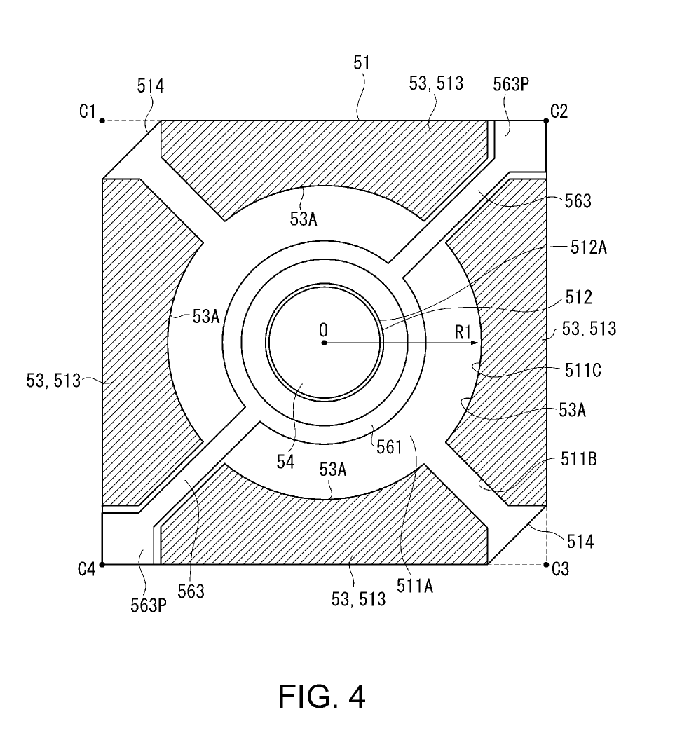

FIG. 4 is a plan view of the fixed substrate 51 in this embodiment viewed from the movable substrate 52 side and is a sectional view of the fixed substrate 51 taken along line IV-IV shown in FIG. 3.

The fixed substrate 51 is formed by machining a glass base material formed in thickness of, for example, 1 mm. Specifically, as shown in FIG. 3, an electrode arranging groove 511 (which forms the concave groove section in the embodiment of the invention) and a reflective-film setting section 512 are formed on the fixed substrate 51 by etching. The fixed substrate 51 is formed in a thickness dimension larger than the thickness dimension of the movable substrate 52. A bend of the fixed substrate 51 due to electrostatic attraction caused when a voltage is applied between the fixed electrode 561 and the movable electrode 562 or internal stress of the fixed electrode 561 does not occur.

Cutout sections 514 are formed at vertexes C1 and C3 (see FIGS. 2 and 4) of the fixed substrate 51. Movable electrode pads 564P explained below are exposed on the fixed substrate 51 side of the wavelength variable interference filter 5.

The electrode arranging groove 511 is formed in an annular shape having a radius R1 with the center set at the plane center point O of the fixed substrate 51 in the filter plan view. The reflective-film setting section 512 is formed to project to the movable substrate 52 side from the center of the electrode arranging groove 511 in the plan view. A flat surface having a curvature radius equal to or larger than 5 mm in the groove bottom surface of the electrode arranging groove 511 is an electrode setting surface 511A on which the fixed electrode 561 is arranged. A projecting distal end face of the reflective-film setting section 512 is a reflective-film setting surface 512A.

Electrode extracting grooves 511B extending from the electrode arranging groove 511 to vertexes C1, C2, C3, and C4 at the outer peripheral edge of the fixed substrate 51 are provided on the fixed substrate 51.

A fixed electrode 561 is formed on the electrode setting surface 511A of the electrode arranging groove 511. More specifically, the fixed electrode 561 is provided in a region opposed to the movable section 521 explained below on the electrode setting surface 511A. An insulative film for securing insulation properties between the fixed electrode 561 and the movable electrode 562 may be laminated on the fixed electrode 561. Fixed extracting electrodes 563 extending from the outer circumferential edge of the fixed electrode 561 in the directions of the vertexes C2 and C4 are provided on the fixed substrate 51. Extension distal ends (portions located at the vertexes C2 and C4 of the fixed substrate 51) of the fixed extracting electrodes 563 form fixed electrode pads 563P connected to the voltage control section 32.

In this embodiment, the configuration in which one fixed electrode 561 is provided on the electrode setting surface 511A is shown. However, for example, two electrodes formed in concentric circles having the center in the plane center point O may be provided (a double electrode structure).

As explained above, the reflective-film setting section 512 is formed coaxially with the electrode arranging groove 511 and in a substantially columnar shape having a diameter dimension smaller than the diameter dimension of the electrode arranging groove 511. The reflective-film setting section 512 includes the reflective-film setting surface 512A opposed to the movable substrate 52 of the reflective-film setting section 512.

As shown in FIGS. 2 to 4, the fixed reflective film 54 is provided on the reflective-film setting section 512. As the fixed reflective film 54, for example, a metal film of Ag or the like or an alloy film of an Ag alloy or the like can be used. For example, a dielectric multilayer film in which a high refractive layer is formed of TiO₂ and a low refractive layer is formed of SiO₂ may be used. Further, for example, a reflective film formed by laminating a metal film (an alloy film) on a dielectric multilayer film, a reflective film formed by laminating a dielectric multilayer film on a metal film (an alloy film), or a reflective film formed by laminating a refractive layer (TiO₂, SiO₂, etc.) of a single layer and a metal film (an alloy film) may be used.

On a light incident surface (a surface on which the fixed reflective film 54 is not provided) of the fixed substrate 51, a reflection preventing film may be formed in a position corresponding to the fixed reflective film 54. The reflection preventing film can be formed by alternately laminating a low refractive index film and a high refractive index film. The reflection preventing film reduces the reflectance of visible light on the surface of the fixed substrate 51 and increases the transmittance of the visible light.

On the surface of the fixed substrate 51 opposed to the movable substrate 52, a region where the electrode arranging groove 511, the reflective film setting section 512, and the electrode extracting grooves 511B are not formed forms the flat first bonding section 513. The bonding film 53 is provided on the first bonding section 513. In other words, in this embodiment, an inner circumferential edge 53A of the bonding film 53 is aligned with an outer circumferential edge 511C of the electrode arranging groove 511.

### 3-1-2. Configuration of the Movable Substrate

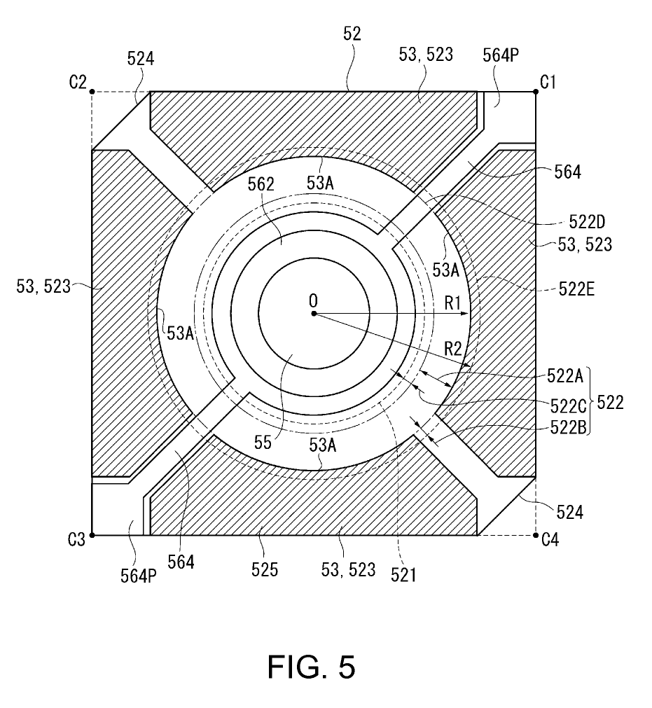

FIG. 5 is a plan view of the movable substrate viewed from the fixed substrate side in the first embodiment and is a sectional view of the movable substrate taken along V-V line shown in FIG. 3.

The movable substrate 52 is formed by etching a glass base material formed in thickness of, for example, 1 mm. Specifically, the movable substrate 52 includes, in the filter plan view shown in FIGS. 2 and 5, a movable section 521 formed in a circular shape having the center in the plane center point O, a holding section 522 that is coaxial with the movable section 521 and holds the movable section 521, and a substrate outer circumferential section 525 provided on the outer circumferential side of the holding section 522.

In the movable substrate 52, as shown in FIGS. 2 and 5, cutout sections 524 are formed to correspond to the vertexes C2 and C4. When the wavelength variable interference filter 5 is viewed from the movable substrate 52 side, the fixed electrode pads 563P are exposed.

The movable section 521 is formed in a thickness dimension larger than the thickness dimension of the holding section 522. For example, in this embodiment, the movable section 521 is formed in a dimension same as the thickness dimension of the movable substrate 52. In the filter plan view, the movable section 521 is formed at least in a diameter dimension larger than the diameter dimension of the outer circumferential edge of the reflective-film setting surface 512A. The movable electrode 562 and the movable reflective film 55 are provided on the movable section 521.

As in the fixed substrate 51, a reflection preventing film may be formed on the surface of the movable section 521 on the opposite side of the fixed substrate 51. The reflection preventing film can be formed by alternately laminating a low refractive index film and a high refractive index film. It is possible to reduce the reflectance of visible light on the surface of the movable substrate 52 and increase the transmittance of the visible light.

The movable electrode 562 is opposed to the fixed electrode 561 via the inter-electrode gap G2 (G2>G1) and formed in an annular shape same as the shape of the fixed electrode 561. The movable substrate 52 includes movable extracting electrodes 564 extending from the outer circumferential edge of the movable electrode 562 to the vertexes C1 and C3 of the movable substrate 52. Extension distal ends (portions located at the vertexes C1 and C3 of the movable substrate 52) of the movable extracting electrodes 564 form the movable electrode pads 564P connected to the voltage control section 32. The movable reflective film 55 is provided to be opposed to the fixed reflective film 54 via the inter-reflective film gap G1 in the center of the movable surface 521A of the movable section 521. As the movable reflective film 55, a reflective film having the same configuration as the fixed reflective film 54 is used.

The holding section 522 is a diaphragm that surrounds the movable section 521. The holding section 522 is formed in a thickness dimension smaller than the thickness dimension of the movable section 521 and formed to have rigidity in the thickness direction smaller than the rigidity of the movable section 521. Specifically, the holding section 522 includes an annular flat section 522A having a uniform thickness dimension of, for example, 20 μm, a curved surface section 522B (which forms the holding outer circumferential section of the embodiment of the invention) continuous to the outer circumferential side of the flat section 522A, and a curved surface section 522C continuous to the inner circumferential side of the flat section 522A.

The thickness dimension of the flat section 522A is uniform. However, “uniform” in this context includes a slight manufacturing error that does not prevent the object of the invention from being attained. For example, in this embodiment, a portion having a curvature radius equal to or larger than at least 5 mm is the flat section 522A. The curved surface section 522B and the curved surface section 522C indicate portions having a curvature radius smaller than at least 5 mm.

Such a holding section 522 is formed by wet-etching the surface of the movable substrate 52 on the opposite side of the fixed substrate 51. When the holding section 522 is formed on the movable substrate 52 by the wet etching, a mask layer having an opening corresponding to the shape of the flat section 522A is formed on the surface of the movable substrate 52. The movable substrate 52 is etched with etchant such as HF. Consequently, the mask layer is etched along the substrate thickness direction from the opening portion of the mask layer while maintaining a flat surface, whereby the flat section 522A having the uniform thickness dimension is formed. On the other hand, in the wet etching, side etching advances from the forming position of the flat section 522A in a direction (the lateral direction) orthogonal to the substrate thickness. Therefore, the curved surface sections 522B and 522C are formed in portions right under the mask layer.

In this embodiment, an outer circumferential edge 522D of the flat section 522A is provided in a position at a radius R1 from the plane center point O and an outer circumferential edge 522E of the curved surface section 522B is provided in a position at a radius R2 (R2>R1) from the plane center point O. In other words, in this embodiment, in the filter plan view, the outer circumferential edge 522E of the curved surface section 522B is located further on the outer side than the inner circumferential edge 53A of the bonding film 53. The outer circumferential edge 522D of the flat section 522A is aligned with the inner circumferential edge 53A of the bonding film 53.

The outer circumferential edge 522D of the flat section 522A is equivalent to the “boundary position of the flat section and the holding outer circumferential surface” according to the invention.

Such a holding section 522 more easily bends than the movable section 521. It is possible to displace the movable section 521 to the fixed substrate 51 side by bending the flat section 522A with slight electrostatic attraction. The movable section 521 has thickness dimension and rigidity larger than the thickness dimension and the rigidity of the holding section 522. Therefore, even if force of bending the movable substrate acts because of electrostatic attraction, the movable section 521 hardly bends. It is possible to prevent a bend of the movable reflective film 55 formed in the movable section 521.

In this embodiment, the holding section 522 having a diaphragm shape is illustrated. However, the holding section 522 is not limited to this. For example, holding sections having a beam shape arranged at equal angle intervals may be provided around the plane center point O.

### 3-2. Configuration of the Voltage Control Section

The voltage control section 32 is connected to the fixed electrode pads 563P and the movable electrode pads 564P. The voltage control section 32 applies a voltage to the electrostatic actuator 56 to drive the electrostatic actuator 56 by setting the fixed electrode pads 563P and the movable electrode pads 564P to predetermined potential on the basis of a control signal input from the control device 4. Consequently, electrostatic attraction is generated in the inter-electrode gap G2 and the flat section 522A of the holding section 522 bends, whereby the movable section 521 is displaced to the fixed substrate 51 side. Therefore, it is possible to set the inter-reflective film gap G1 to a desired dimension.

### 4. Configuration of the Control Device

The control device 4 controls the overall operation of the colorimetric apparatus 1.

As the control device 4, for example, a general-purpose personal computer, a portable information terminal, a computer exclusive for colorimetry, or the like can be used.

The control device 4 includes, as shown in FIG. 1, a light-source control section 41, a colorimetric-sensor control section 42, and a colorimetric processing section 43, which forms an analysis processing section in the embodiment of the invention.

The light-source control section 41 is connected to the light source device 2. The light-source control section 41 outputs a predetermined control signal to the light source device 2 on the basis of, for example, a setting input of a user and causes the light source device 2 to emit white light having predetermined brightness.

The colorimetric-sensor control section 42 is connected to the colorimetric sensor 3. The colorimetric-sensor control section 42 sets the wavelength of light received by the colorimetric sensor 3 on the basis of, for example, a setting input of the user and outputs a control signal for instructing to detect a received light amount of the light having the wavelength to the colorimetric sensor 3. The voltage control section 32 of the colorimetric sensor 3 sets, on the basis of the control signal, an applied voltage to the electrostatic actuator 56 to transmit only wavelength of light desired by the user.

The colorimetric processing section 43 analyzes the chromaticity of the inspection target A from the received light amount detected by the detecting section 31.

### 5. Manufacturing Method for the Wavelength Variable Interference Filter

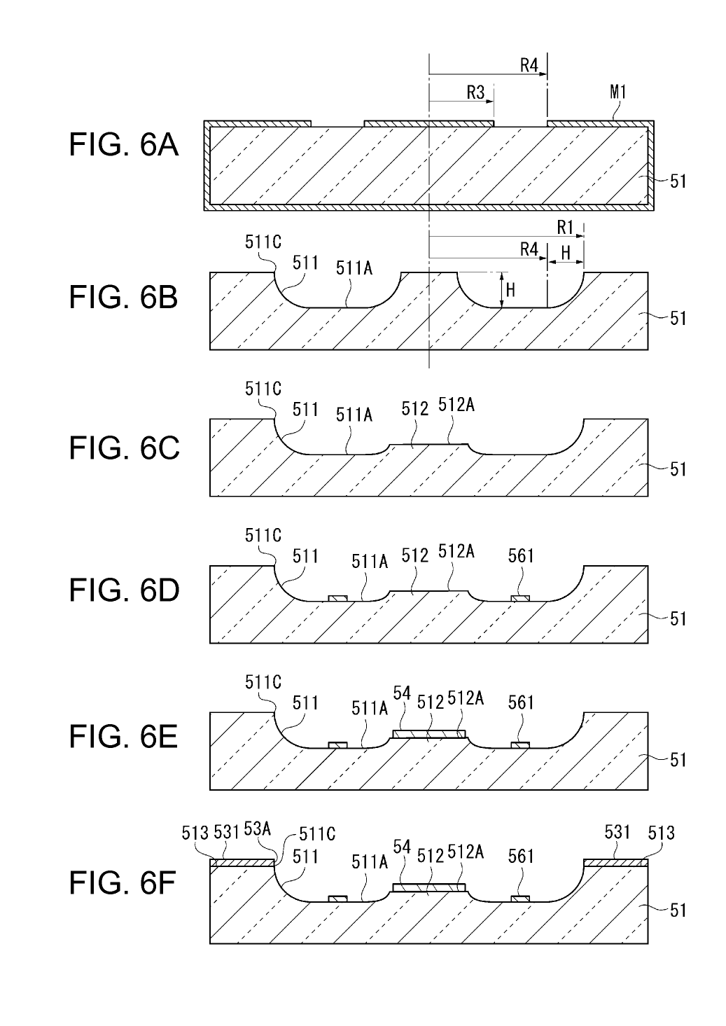

A manufacturing method for the wavelength variable interference filter 5 is explained with reference to FIGS. 6A to 6F, FIGS. 7A to 7E, and FIG. 8.

In order to manufacture the wavelength variable interference filter 5, the fixed substrate 51 and the movable substrate 52 are separately manufactured and the manufactured fixed substrate 51 and the manufactured movable substrate 52 are stuck together.

### 5-1. Fixed Substrate Manufacturing Process

First, a quartz glass substrate having a thickness dimension of 1 mm, which is a material for manufacturing the fixed substrate 51, is prepared. Both the surfaces of the quartz glass substrate are precisely polished until surface roughness Ra of the quartz glass substrate decreases to 1 nm or less. Thereafter, as shown in FIG. 6A, a mask layer M1 (resist) is applied to the surface of the fixed substrate 51 opposed to the movable substrate 52. The applied mask layer M1 (the resist) is exposed to light and developed by a photolithography method to pattern a place where the electrode arranging groove 511 is formed. At this point, the mask layer M1 is patterned such that an opening section of the mask layer M1 corresponds to the shape of the electrode setting surface 511A (an annular shape having radiuses R3 and R4) and the outer circumferential edge 511C of the electrode arranging groove 511 after the etching is located in a position at the radius R1 from the plane center point O.

In general, when isotropic etching is performed by wet etching, side etching advances in the lateral direction (the direction orthogonal to the substrate thickness direction) by a dimension same as etching depth. Therefore, when the depth dimension of the electrode arranging groove 511 is represented as H, the patterning of the mask layer M1 only has to be carried out to realize a relation R4+H=R1.

Subsequently, as shown in FIG. 6B, the electrode arranging groove 511 is etched to a desired depth dimension H. As the etching, wet etching is performed using hydrofluoric acid etchant. According to this etching, side etching advances in a portion right under the mask layer M1 from the opening of the fixed substrate 51. Consequently, the outer circumferential edge 511C of the electrode arranging groove 511 is formed in the position at the radius R1 from the plane center point O. At this point, an electrode extraction grooves 511B are formed simultaneously with the electrode arranging groove 511.

Thereafter, after the mask layer M1 for the electrode arranging groove 511 formation is removed, a mask layer (resist) for forming the reflective-film setting section 512 is formed. A place where the reflective-film setting surface 512A is formed is patterned. At this point, the mask layer may form a pattern opened only in the forming position of the reflective-film setting surface 512A or may form a pattern opened on the inner side of the inner circumferential edge (a circle having the radius R3 from the plane center point O) of the electrode setting surface 511A.

As shown in FIG. 6C, the reflective-film setting surface 512A is etched to be formed at desired height and the mask layer (the resist) is removed. Consequently, a substrate shape of the fixed substrate 51 on which the electrode arranging groove 511 and the reflective-film setting section 512 are formed is determined.

Subsequently, a film of an electrode material for forming the fixed electrode 561 on the fixed substrate 51 is formed. The film is patterned using the photolithography method to form the fixed electrode 561 as shown in FIG. 6D. At this point, the fixed extracting electrodes 563 are simultaneously formed. When an insulating layer is formed on the fixed electrode 561, after the formation of the fixed electrode 561, a film of SiO₂ having thickness of, for example, about 100 nm is formed over the entire surface of the fixed substrate 51 opposed to the movable substrate 52 by, for example, plasma CVD. The SiO₂ film on the fixed electrode pads 563P is removed by, for example, dry etching.

As shown in FIG. 6E, the fixed reflective film 54 is formed on the reflective-film setting surface 512A. In this embodiment, an Ag alloy is used as the fixed reflective film 54. When a metal film of Ag or the like or an alloy film of an Ag alloy or the like is used as the fixed reflective film 54, after a film layer of the fixed reflective film 54 is formed on the surface of the fixed substrate 51 on which the electrode arranging groove 511 and the reflective-film setting section 512 are formed, the film layer is patterned by the photolithography method or the like.

When a dielectric multilayer film is formed as the fixed reflective film 54, the dielectric multilayer film can be formed by, for example, a lift-off process. In this case, resist (a lift-off pattern) is formed in a portion other than a mirror forming portion on the fixed substrate 51 by the photolithography method or the like. Thereafter, a material (e.g., a dielectric multilayer film in which a high refractive layer is formed of TiO₂ and a low refractive layer is formed of SiO₂) for forming the fixed reflective film 54 is formed by a sputtering method, a vapor deposition method, or the like. After the fixed reflective film 54 is formed, the film in unnecessary portions is removed by lift-off.

Thereafter, as shown in FIG. 6F, the plasma polymer film 531 containing polyorganosiloxane as a main component, which forms the bonding film 53, is formed on the first bonding section 513 of the fixed substrate 51 by, for example, a plasma CVD method. In a film forming process for the plasma polymer film 531, the plasma polymer film 531 is formed on the first bonding section 513 of the fixed substrate 51 using, for example, a mask opened in a position corresponding to the first bonding section 513. The thickness of the plasma polymer film 531 only has to be set to, for example, 10 nm to 1000 nm. Consequently, the fixed substrate 51 is manufactured.

### 5-2. Movable Substrate Manufacturing Process

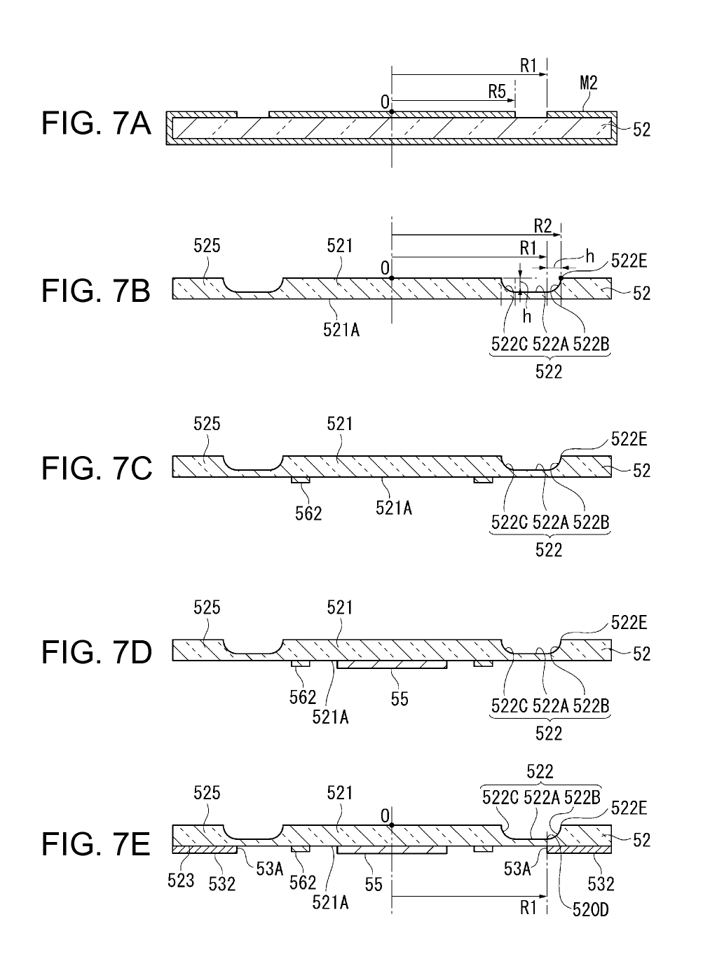

First, as shown in FIG. 7A, a quartz glass substrate having a thickness dimension of 1000 μm, which is a material for forming the movable substrate 52, is prepared. Both the surfaces of the quartz glass substrate are precisely polished until surface roughness Ra of the quartz glass substrate decreases to 1 nm or less. A mask layer M2 (resist) is applied to the entire surface of the movable substrate 52. The applied mask layer M2 is exposed to light and developed by the photolithography method to pattern the mask layer M2. At this point, the mask layer M2 is patterned such that an opening section of the mask layer M2 is opposed to the shape (an annular shape having radiuses R5 and R1) of the flat section 522A of the holding section 522. In this embodiment, the mask layer M2 is formed such that the width (R1-R5) of the flat section 522A is 700 μm.

Subsequently, the quartz glass substrate is wet-etched to form the holding section 522 having thickness of, for example, 20 μm and the movable section 521 as shown in FIG. 7B. As explained above, in the wet etching, side etching advances by a dimension same as the depth dimension of the etching. Therefore, when the etching depth is represented as h, the outer circumferential edge 522E of the curved surface section 522B of the holding section 522 is formed in a position represented as R2=R1+h.

Consequently, a substrate shape of the movable substrate 52 including the movable section 521, the holding section 522, and the substrate outer circumferential section 525 is determined.

As shown in FIG. 7C, the movable electrode 562 is formed on the movable surface 521A. In the formation of the movable electrode 562, like the formation of the fixed electrode 561 on the fixed substrate 51, a film of an electrode material is formed on the movable substrate 52. The film is patterned using the photolithography method to form the movable electrode 562. The movable extracting electrodes 564 are simultaneously formed.

Thereafter, as shown in FIG. 7D, the movable reflective film is formed on the movable surface 521A. The movable reflective film 55 can be formed by a method same as the method of forming the fixed reflective film 54. When a metal film of Ag or the like or an alloy film of an Ag alloy or the like is used as the movable reflective film 55, after a film layer of the movable reflective film 55 is formed on the movable substrate 52, the film layer is patterned using the photolithography method. When a dielectric multilayer film is formed as the movable reflective film 55, the dielectric multilayer film can be formed by, for example, the lift-off process.

Thereafter, as shown in FIG. 7E, the plasma polymer film 532 containing polyorganosiloxane as a main component is formed on the second bonding section 523 of the movable substrate 52 by, for example, the plasma CVD method. In this process for forming the plasma polymer film 532, the plasma polymer film 532 is formed on the second bonding section 523 of the movable substrate 52 using, for example, a mask opened in a position corresponding to the second bonding section 523. The thickness of the plasma polymer film 532 only has to be set to, for example, 10 nm to 1000 nm.

Consequently, the movable substrate 52 is manufactured.

### 5-3. Bonding Process

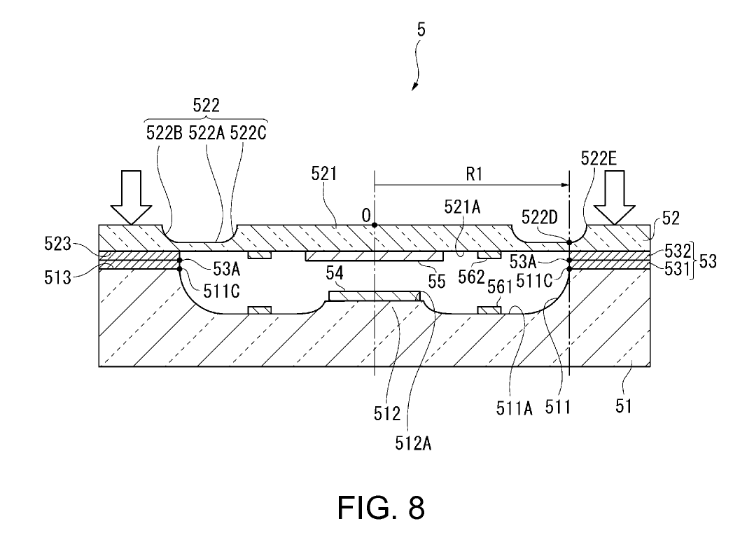

Subsequently, the substrates formed in the fixed substrate manufacturing process and the movable substrate manufacturing process are bonded. FIG. 8 is a diagram showing a bonding process.

In this bonding process, first, O₂ plasma treatment or UV treatment is performed to give activation energy to the plasma polymer films 531 and 532 formed on the first bonding section 513 of the fixed substrate 51 and the second bonding section 523 of the movable substrate 52. The O₂ plasma treatment is carried out for thirty seconds under conditions of an O₂ flow rate of 30 cc/min, pressure of 27 Pa, and RF power of 200 W. The UV treatment is performed for three minutes using excimer UV (having wavelength of 172 nm) as a UV light source.

After the activation energy is given to the plasma polymer films 531 and 532, alignment of the fixed substrate 51 and the movable substrate 52 is performed to lay the first bonding section 513 and the second bonding section 523 one on top of the other via the plasma polymer films 531 and 532. At this point, the fixed substrate 51 and the movable substrate 52 are laid one top of the other such that the outer circumferential edge 522D of the holding section 522 and the outer circumferential edge 511C of the electrode arranging groove 511 are aligned with each other.

A load of, for example, 10 kgh is applied to a bonding portion for ten minutes to pressurize and bond the bonding portion. Consequently, the substrates 51 and 52 are bonded.

During the pressurizing and bonding, if a load is applied to the movable section 521 and the holding section 522 of the movable substrate 52, the holding section 522 bends and the fixed reflective film 54 and the movable reflective film 55 come into contact with each other. Therefore, as shown in FIG. 8, a load is applied to the substrate outer circumferential section 525 of the movable substrate 52 to bond the plasma polymer films 531 and 532 and form the bonding film 53.

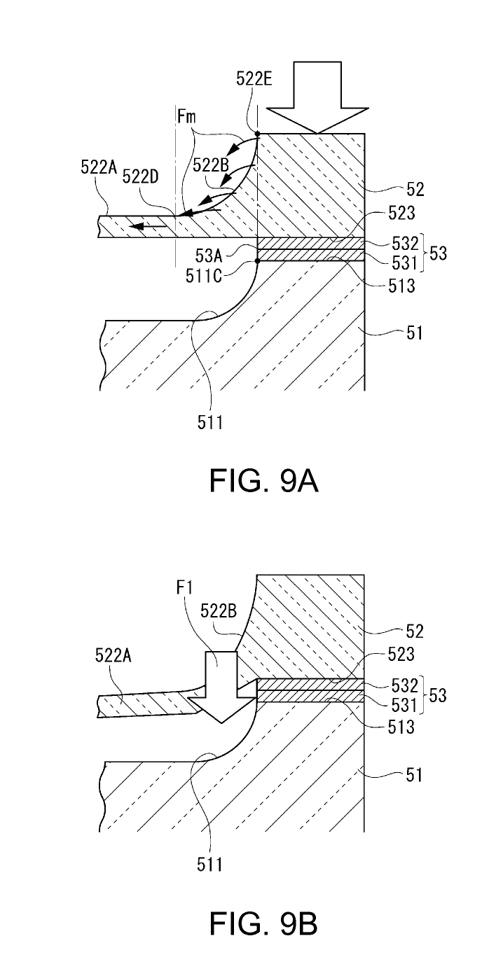

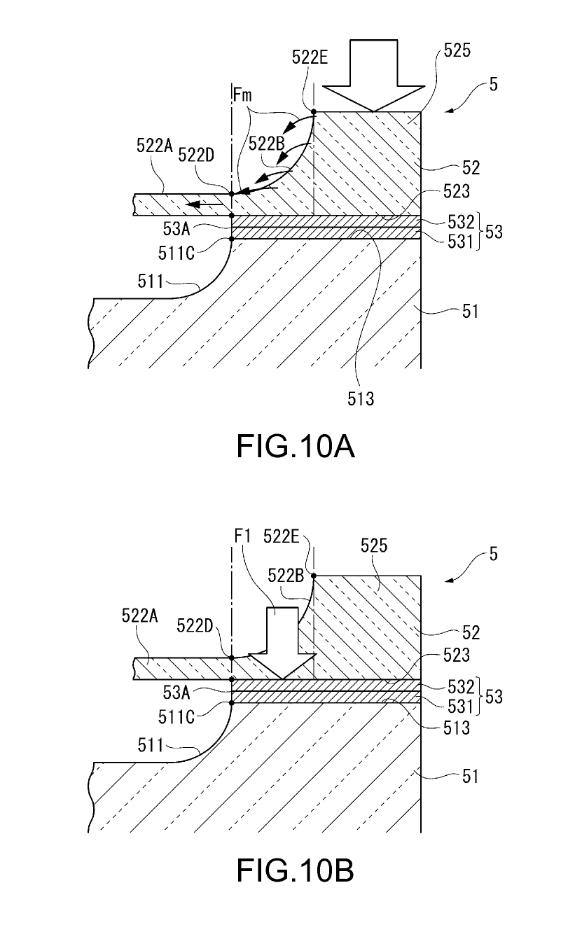

FIGS. 9A and 9B are diagrams showing how a force is applied during the pressurizing and bonding when the outer circumferential edge 522E of the curved surface section 522B overlaps the inner circumferential edge 53A of the bonding film 53. FIGS. 10A and 10B are diagrams showing how force is applied during the pressurizing and bonding in this embodiment. In the pressurizing and bonding, when a load is applied to the substrate outer circumferential section 525, moment force Fm corresponding to a load applied to the curved surface section 522B is generated. The moment force Fm changes according to inclination of the holding section 522 with respect to the substrate thickness direction. In a position closer to the flat section 522A, the moment force Fm acts in the direction orthogonal to the substrate thickness direction. Therefore, as shown in FIGS. 9A and 9B, when the outer circumferential edge 522E of the holding section 522 overlaps the inner circumferential edge 53A of the bonding film 53 or when the outer circumferential edge 522E is located further on the inner circumferential side than the inner circumferential edge 53A of the bonding film 53, force F1 of bending the curved surface section 522B to the fixed substrate 51 side is generated and a bend occurs in the holding section 522. In such a case, the bend sometimes remains after the substrate bonding. The initial dimension of the inter-reflective film gap G1 sometimes decreases. Depending on a load, the fixed reflective film 54 and the movable reflective film 55 come into contact with each other. It is likely that the reflection characteristic of the fixed reflective film 54 and the movable reflective film 55 is deteriorated.

On the other hand, in this embodiment, as shown in FIG. 10, even if the moment force is generated in the curved surface section 522B and the force F1 of bending the curved surface section 522B to the fixed substrate 51 side is generated, the forces can be received by the bonding film 53 and the fixed substrate 51 (the first bonding section 513). A bend does not occur in the curved surface section 522B. Therefore, the holding section 522 does not bend during the pressurizing and bonding. The inclination of the movable substrate 52 does not occur either. Further, the contact of the fixed reflective film 54 and the movable reflective film 55 does not occur.

### 6. Action and Effects of the Embodiment

In the wavelength variable interference filter 5 according to this embodiment, in the filter plan view, the inner circumferential edge 53A of the bonding film 53 is located further on the inner side than the outer circumferential edge 522E of the curved surface section 522B. The curved surface section 522B overlaps the bonding film 53. In such a configuration, even if the force F1 of bending the curved surface section 522B to the fixed substrate 51 side is generated by the moment force Fm generated during the pressurizing and bonding of the fixed substrate 51 and the movable substrate 52, the force F1 can be received by the bonding film 53 and the first bonding section 513. Therefore, it is possible to reduce a bend of the movable substrate 52 during the pressurizing and bonding and prevent the inclination of the movable substrate 52. During manufacturing, it is possible to prevent the contact of the fixed reflective film 54 and the movable reflective film 55 due to load application. Therefore, it is possible to maintain the reflection characteristic of the reflective films 54 and 55.

The inner circumferential edge 53A of the bonding film 53 is aligned with the outer circumferential edge 522D of the flat section 522A. Therefore, when the inter-reflective film gap G1 is changed, it is possible to easily displace the movable section 521 by bending the entire flat section 522A.

The fixed substrate 51 includes the electrode arranging groove 511. The entire outer circumferential side region of the electrode arranging groove 511 forms the first bonding section 513. In such a configuration, it is possible to increase an area for bonding the fixed substrate 51 and the movable substrate 52 and increase bonding strength.

### Second Embodiment

A second embodiment of the invention is explained with reference to the accompanying drawings.

In the colorimetric apparatus 1 according to the first embodiment, the wavelength variable interference filter 5 is directly provided in the colorimetric sensor 3, which is the optical module. In this case, the wavelength variable interference filter 5 is provided in a predetermined arrangement position provided in the colorimetric sensor 3. Wiring is carried out for the fixed electrode pads 563P and the movable electrode pads 564P. However, some optical module has a complicated configuration. In particular, it is sometimes difficult to directly provide the wavelength variable interference filter 5 in a small optical module. In this embodiment, an optical filter device that enables the wavelength variable interference filter 5 to be easily set even in such an optical module is explained below.

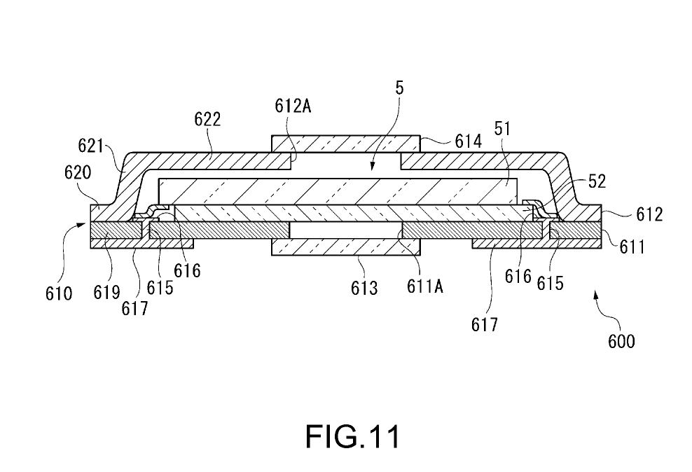

FIG. 11 is a sectional view showing a schematic configuration of the optical filter device according to the second embodiment of the invention.

As shown in FIG. 11, an optical filter device 600 includes a housing 610 that houses the wavelength variable interference filter 5.

The housing 610 includes a bottom section 611, a lid 612, an incident side glass window 613 (a light guiding section), and an emission side glass window 614 (a light guiding section). The bottom section 611 is formed by, for example, a single layer ceramic substrate. The movable substrate 52 of the wavelength variable interference filter 5 is fixed to the bottom section 611. On the bottom section 611, a light incident hole 611A is opened and formed in a region opposed to the reflective films 54 and 55 of the wavelength variable interference filter 5. The light incident hole 611A is a window on which incident light (inspection target light) desired to be split by the wavelength variable interference filter 5 is made incident. The incident side glass window 613 is bonded to the light incident hole 611A. As the bonding of the bottom section 611 and the incident side glass window 613, for example, glass frit bonding can be used in which glass frits, which are fragments of glass obtained by melting a glass material at high temperature and rapidly cooling the glass material, are used.

On the upper surface of the bottom section 611 (on the inner side of the housing 610), terminal sections 616 are provided in a number corresponding to the electrode pads 563P and 564P of the wavelength variable interference filter 5. In the bottom section 611, through-holes 615 are formed in positions where the terminal sections 616 are provided. The terminal sections 616 are connected to connection terminals 617 provided on the lower surface of the bottom section 611 (on the outer side of the housing 610) via the through-holes 615.

A sealing section 619 bonded to the lid 612 is provided at the outer circumferential edge of the bottom section 611.

The lid 612 includes, as shown in FIG. 11, a sealing section 620 bonded to the sealing section 619 of the bottom section 611, a sidewall section 621 continuous from the sealing section 620 and standing in a direction away from the bottom section 611, and a top surface section 622 continuous from the sidewall section 621 and covering the fixed substrate 51 side of the wavelength variable interference filter 5. The lid 612 can be formed of an alloy such as Kovar or metal.

The sealing section 620 and the sealing section 619 of the bottom section 611 are bonded by, for example, laser sealing, whereby the lid 612 is bonded to the bottom section 611. In the top surface section 622 of the lid 612, a light emission hole 612A is opened and formed in a region opposed to the reflective films 54 and 55 of the wavelength variable interference filter 5. The light emission hole 612A is a window through which light split and extracted by the wavelength variable interference filter 5 passes. The emission side glass window 614 is bonded to the light emission hole 612A by, for example, the glass frit bonding.

In the housing 610, an inert gas such as a nitrogen or argon gas may be encapsulated or a high degree of vacuum may be maintained. By adopting such a configuration, it is possible to prevent deterioration of the reflective films 54 and 55 of the wavelength variable interference filter 5. When the housing 610 is maintained in a state in which a degree of vacuum is high, it is possible to improve responsiveness of the movable section 521 when a voltage is applied to the electrostatic actuator 56 of the wavelength variable interference filter 5. In such an optical filter device 600, since the wavelength variable interference filter 5 is protected by the housing 610, it is possible to prevent a change in the characteristics of the wavelength variable interference filter 5 due to foreign matters, gas included in the atmosphere, or the like and prevent breakage of the wavelength variable interference filter 5 due to an external factor. Therefore, it is possible to prevent breakage due to, for example, collision with another member when the wavelength variable interference filter 5 is set in an optical module such as a colorimetric sensor or an electronic apparatus or during maintenance.

For example, when the wavelength variable interference filter 5 manufactured in a factory is transported to an assembly line or the like for assembling the optical module or the electronic apparatus, it is possible to safely transport the wavelength variable interference filter 5 protected by the optical filter device 600.

In the optical filter device 600, the connection terminals 617 exposed to the outer circumferential surface of the housing 610 are provided. Therefore, it is possible to easily carry out wiring even when the wavelength variable interference filter 5 is incorporated in the optical module or the electronic apparatus.

In the second embodiment, the configuration in which the movable substrate 52 is fixed to the bottom section 611 is illustrated. However, the configuration of the wavelength variable interference filter 5 is not limited to this. For example, the fixed substrate 51 may be fixed to the bottom section 611.

### Other Embodiments

The invention is not limited to the embodiments explained above. Modifications, improvements, and the like within a range in which the object of the invention can be attained are included in the invention.

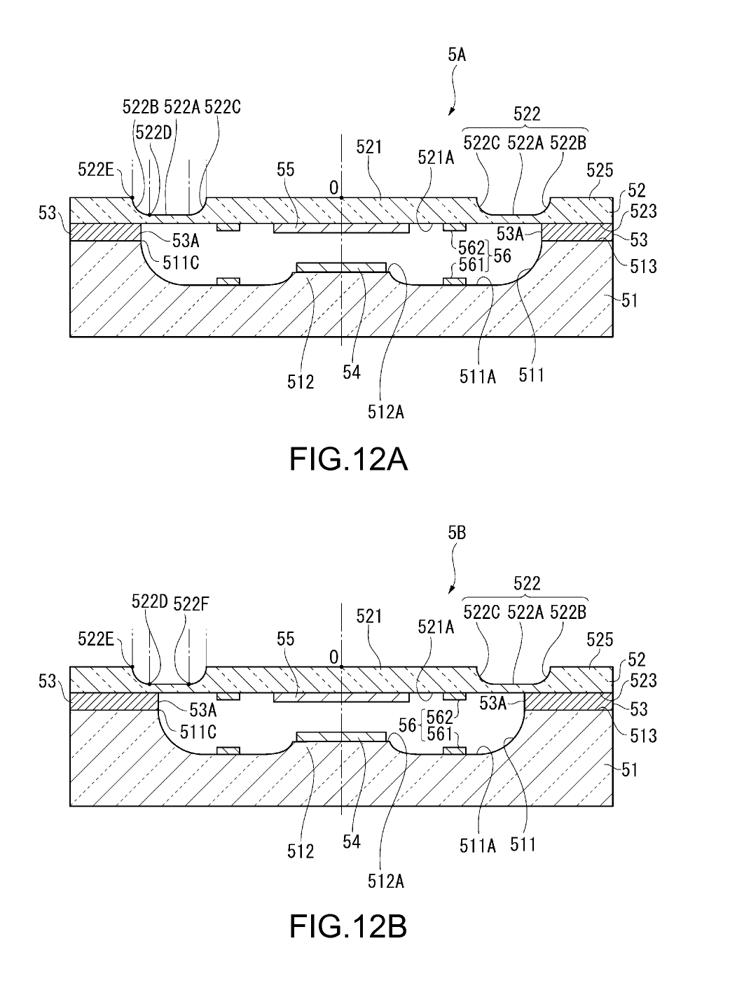

For example, in the embodiments, the outer circumferential edge 522D of the flat section 522A and the inner circumferential edge 53A of the bonding film 53 are aligned. However, the configuration of the wavelength variable interference filter 5 is not limited to this. The wavelength variable interference filter 5 may be configured like a wavelength variable interference filter 5A and a wavelength variable interference filter 5B shown in FIGS. 12A and 12B.

Specifically, as shown in FIG. 12A, in the filter plan view, the inner circumferential edge 53A of the bonding film 53 may be located between the outer circumferential edge 522D of the flat section 522A and the outer circumferential edge 522E of the curved surface section 522B. In such a configuration, as in the configuration explained above, it is possible to prevent a bend of the movable substrate 52 compared with, for example, the configuration in which the outer circumferential edge 522E of the curved surface section 522B is located further on the inner circumferential side than the inner circumferential edge 53A of the bonding film 53.

As shown in FIGS. 9A and 9B and FIGS. 10A and 10B, the moment force Fm applied to the curved surface section 522B during the pressurizing and bonding changes according to an inclination angle in the curved surface section 522B. Force in the substrate thickness direction decreases from the outer circumferential edge 522E of the curved surface section 522B toward the outer circumferential edge 522D of the flat section 522A. Therefore, since the vicinity of the outer circumferential edge 522E where the force in the substrate thickness direction is the largest in the curved surface section 522B is provided right above the bonding film 53, it is possible to sufficiently suppress a bend of the movable substrate 52.

As shown in FIG. 12B, in the filter plan view, the inner circumferential edge 53A of the bonding film 53 may be provided between the outer circumferential edge 522D of the flat section 522A and an inner circumferential edge 522F of the flat section 522A.

When the inner circumferential edge 53A of the bonding film 53 is aligned with the inner circumferential edge 522F of the flat section 522A or when the inner circumferential edge 53A is present further on the inner circumferential side than the inner circumferential edge 522F, the movable section 521 cannot be bent. However, when the inner circumferential edge 53A is present further on the outer circumferential side than the inner circumferential edge 522F, it is possible to displace the movable section 521 by bending the flat section 522A in a region not overlapping the bonding film 53. In such a configuration, it is possible to surely prevent a bend of the movable substrate 52 during the pressurizing and bonding.

Further, in the embodiments, the configuration in which the bonding film 53 is provided on the entire surface of the first bonding section 513 is illustrated. However, for example, the bonding film 53 may be provided in a part of the first bonding section 513. In this case, as in the embodiments, the inner circumferential edge 53A of the bonding film 53 is aligned with the outer circumferential edge 511C of the electrode arranging groove 511 and the curved surface section 522B is provided in a position overlapping the bonding film 53. Consequently, it is possible to obtain effects same as the effects of the embodiments.

In the embodiments, the configuration in which the fixed substrate 51, which is the first substrate, and the movable substrate 52, which is the second substrate, are bonded by the bonding film 53, which is the bonding section, and are siloxane-bonded using the plasma polymer film as the bonding film 53 is illustrated. However, the bonding of the fixed substrate 51 and the movable substrate 52 is not limited to this.

For example, as the bonding film 53, an ultraviolet curable adhesive or the like may be used. For example, a metal film functioning as the bonding film may be provided in any one of the first substrate and the second substrate made of glass to anodically bond the metal film and the other substrate.

Another layer does not have to be interposed between the first substrate and the second substrate. In this case, a region where the substrates are in contact with each other on surfaces opposed to each other of the first substrate and the second substrate is the bonding section in the embodiment of the invention. The inner circumferential edge of the bonding section only has to be located further on the inner side than the outer circumferential edge of the holding outer circumferential section. As such bonding, for example, when anyone of the first substrate and the second substrate is glass and the other is a conductive member such as silicon, the substrates are directly anodically bonded. Besides, the surfaces opposed to each other of the first substrate and the second substrate are formed as optical surfaces and the substrates are bonded by optical contact bonding.

In the embodiments, the configuration in which, in the holding section 522, the curved surface sections 522B and 522C are formed around the flat section 522A is illustrated. However, the configuration of the holding section 522 is not limited to this. For example, when a silicon substrate is used as the movable substrate 52 (the second substrate) and anisotropic etching is carried out with KOH, a taper-like holding outer circumferential section, sectional view of an etching surface of which is a straight line inclining with respect to the substrate thickness direction, is formed in the circumferential section of the flat section 522A. In this case, as in the embodiments, the inner circumferential edge 53A of the bonding film 53 is located further on the outer side than the outer circumferential edge 522D of the flat section 522A. Therefore, it is possible to reduce force of bending the holding outer circumferential section to the fixed substrate 51 side and prevent a bend of the movable substrate 52.

In the embodiments, the wavelength variable interference filter 5 that causes light made incident from the fixed substrate 51 side to interfere between the fixed reflective film 54 and the movable reflective film 55 and emits extracted light from the movable substrate 52 side is illustrated. However, the wavelength variable interference filter 5 is not limited to this configuration.

For example, the wavelength variable interference filter 5 may be configured to emit the light extracted through the light interference between the fixed reflective film 54 and the movable reflective film 55 to the fixed substrate 51 side again. In this case, a non-translucent member may be used as the movable substrate 52.

The colorimetric apparatus 1 is illustrated as the electronic apparatus in the embodiment of the invention. However, besides, the wavelength variable interference filter, the optical module, and the electronic apparatus in the embodiment of the invention can be used in various fields.

For example, the wavelength variable interference filter, the optical module, and the electronic apparatus can be used as a system of an optical base for detecting the presence of a specific substance. As such a system, a gas detecting apparatus can be illustrated, such as a vehicle-mounted gas leakage detector that adopts a spectroscopic measurement method in which the wavelength variable interference filter in the embodiment of the invention is used and detects a specific gas at high sensitivity or an optoacoustic rare gas detector for exhalation check.

An example of such a gas detecting apparatus is explained below with reference to the accompanying drawings.

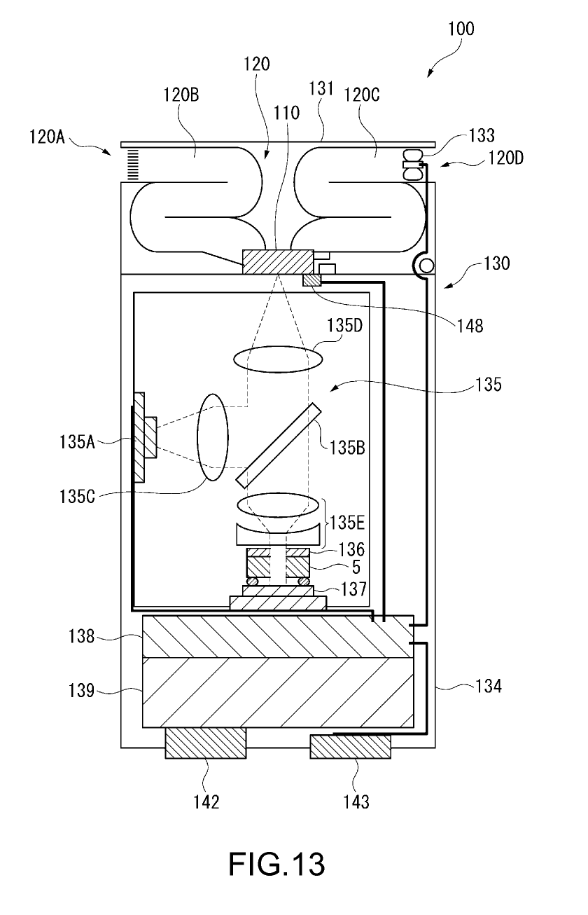

FIG. 13 is a schematic diagram showing an example of the gas detecting apparatus including the wavelength variable interference filter.

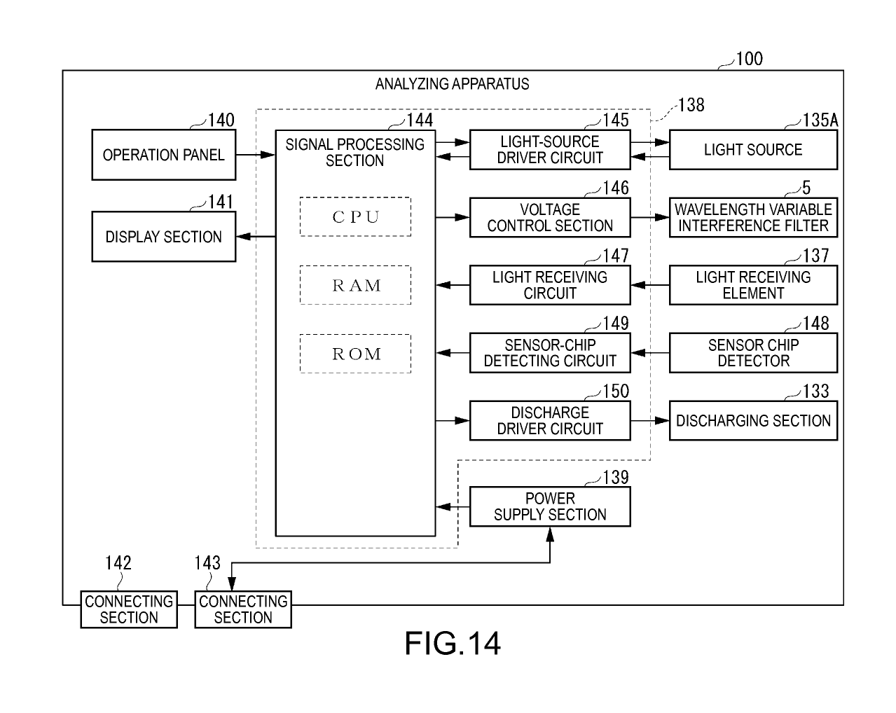

FIG. 14 is a block diagram showing the configuration of a control system of the gas detecting apparatus shown in FIG. 13.

A gas detecting apparatus 100 includes, as shown in FIG. 13, a sensor chip 110, a channel 120 including a suction port 120A, a suction channel 120B, a discharge channel 120C, and a discharge port 120D, and a main body section 130.

The main body section 130 includes a detecting device (an optical module) including a sensor section cover 131 including an opening through which the channel 120 can be attached and detached, a discharging section 133, a housing 134, an optical section 135, a filter 136, the wavelength variable interference filter 5, and a light receiving element 137 (a detecting section), a control section 138 that processes a detected signal and controls the detecting section, and a power supply section 139 that supplies electric power. The optical section 135 includes a light source 135A that emits light, a beam splitter 135B that reflects the light made incident from the light source 135A to the sensor chip 110 side and transmits light made incident from the sensor chip 110 side to the light receiving element 137 side, and lenses 135C, 135D, and 135E. A configuration in which the wavelength variable interference filter 5 is used is illustrated. However, the wavelength variable interference filters 5A or 5B may be used. The optical filter device 600 in the second embodiment in which the wavelength variable interference filter 5 (5A or 5B) is housed may be used.

As shown in FIG. 14, an operation panel 140, a display section 141, a connecting section 142 for interface with the outside, and the power supply section 139 are provided on the surface of the gas detecting apparatus 100. When the power supply section 139 is a secondary battery, the gas detecting apparatus 100 may include a connecting section 143 for charging.

Further, the control section 138 of the gas detecting apparatus 100 includes, as shown in FIG. 14, a signal processing section 144 including a CPU, a light-source driver circuit 145 for controlling the light source 135A, a voltage control section 146 for controlling the wavelength variable interference filter 5, a light receiving circuit 147 that receives a signal from the light receiving element 137, a sensor-chip detecting circuit 149 that receives a signal from a sensor chip detector 148 that reads a code of the sensor chip 110 and detects presence or absence of the sensor chip 110, and a discharge driver circuit 150 that controls the discharging section 133.

The operation of the gas detecting apparatus 100 explained above is explained below.

The sensor chip detector 148 is provided on the inside of the sensor section cover 131 in an upper part of the main body section 130. The sensor chip detector 148 detects presence or absence of the sensor chip 110. When the signal processing section 144 detects a detection signal from the sensor chip detector 148, the signal processing section 144 determines that the sensor chip 110 is mounted. The signal processing section 144 outputs, to the display section 141, a display signal for causing the display section 141 to display a message that a detecting operation can be carried out.

When the operation panel 140 is operated by, for example, a user and an instruction signal for instructing a start of detection processing is output from the operation panel 140 to the signal processing section 144, first, the signal processing section 144 outputs a signal for light source actuation to the light-source driver circuit 145 and actuates the light source 135A. When the light source 135A is driven, the light source 135A emits a stable laser beam having single wavelength and linear polarization. The light source 135A incorporates a temperature sensor and a light amount sensor. Information of the temperature sensor and the light amount sensor is output to the signal processing section 144. When the signal processing section 144 determines, on the basis of temperature and a light amount input from the light source 135A, that the light source 135A is stably operating, the signal processing section 144 controls the discharge driver circuit 150 to actuate the discharging section 133. Consequently, a gas sample containing a target substance (gas molecules) that should be detected is guided from the suction port 120A to the suction channel 120B, the inside of the sensor chip 110, the discharge channel 120C, and the discharge port 120D.

The sensor chip 110 is a sensor that incorporates plural metal nano-structures and makes use of localized surface plasmon resonance. In such a sensor chip 110, a reinforced electric field is formed among the metal nano-structures by a laser beam. When the gas molecules intrude into the reinforced electric field, Raman scattering light and Rayleigh scattering light including information concerning molecule oscillation are generated.

The Raman scattering light and the Rayleigh scattering light are made incident on the filter 136 through the optical section 135. The Rayleigh scattering light is separated by the filter 136. The Raman scattering light is made incident on the wavelength variable interference filter 5. The signal processing section 144 controls the voltage control section 146, adjusts a voltage applied to the wavelength variable interference filter 5, and causes the wavelength variable interference filter 5 to split the Raman scattering light corresponding to detection target gas molecules. Thereafter, when the split light is received by the light receiving element 137, the light receiving element 137 outputs a light reception signal corresponding to a received light amount to the signal processing section 144 via the light receiving circuit 147. The signal processing section 144 compares spectrum data of the Raman scattering light corresponding to the detection target gas molecules obtained as explained above and data stored in a ROM, determines whether the gas molecules are target gas molecules, and specifies a substance. The signal processing section 144 causes the display section 141 to display information concerning a result of the specification of the substance or outputs the information to the outside from the connecting section 142.

In FIGS. 13 and 14, the gas detecting apparatus 100 is illustrated that splits the Raman scattering light using the wavelength variable interference filter 5 and performs gas detection from the split Raman scattering light. However, as the gas detecting apparatus, a gas detecting apparatus that specifies a gas type by detecting absorbance peculiar to gas may be used. In this case, a gas sensor that causes the gas to flow into a sensor and detects light absorbed by the gas in incident light is used as the optical module in the embodiment of the invention. A gas detecting apparatus that analyzes and discriminates the gas caused to flow into the sensor by such a gas sensor is the electronic apparatus in the embodiment of the invention. With such a configuration, it is possible to detect a component of gas using the wavelength variable interference filter in the embodiment of the invention.

The system for detecting the presence of a specific substance is not limited to the system for detecting gas explained above. As the system, a substance component analyzing apparatus such as a noninvasive measuring apparatus for a saccharide by near infrared ray spectroscopy or a noninvasive measuring apparatus for information concerning foods, organisms, minerals, and the like can be illustrated.

A food analyzing apparatus is explained below as an example of the substance component analyzing apparatus.

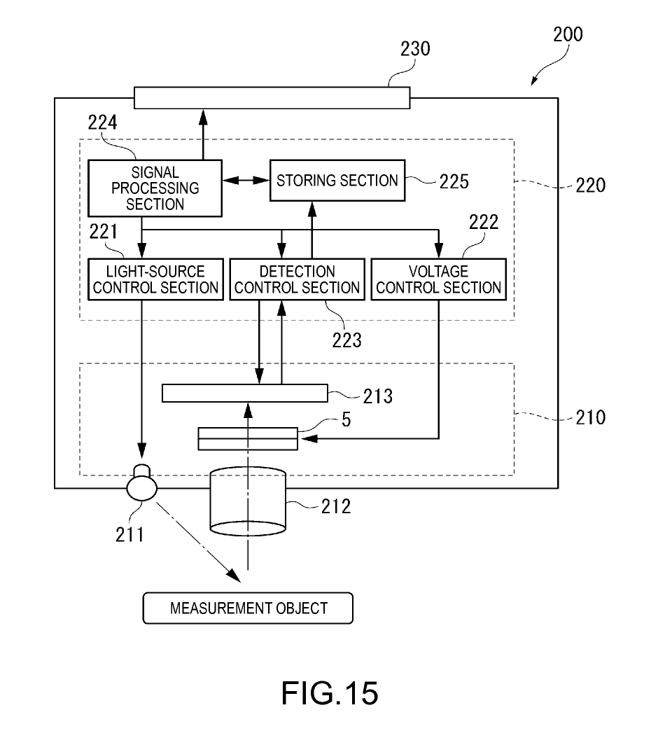

FIG. 15 is a diagram showing a schematic configuration of the food analyzing apparatus, which is an example of an electronic apparatus in which the wavelength variable interference filter is used. Although the wavelength variable interference filter 5 is used, the wavelength variable interference filter 5A or 5B may be used. Further, the optical filter device 600 in the second embodiment in which the wavelength variable interference filter 5 (5A or 5B) is housed may be used.

A food analyzing apparatus 200 includes, as shown in FIG. 15, a detector 210 (an optical module), a control section 220, and a display section 230. The detector 210 includes a light source 211 that emits light, an image pickup lens 212 into which light from a measurement object is led, the wavelength variable interference filter 5 that splits the light led in from the image pickup lens 212, and an image pickup section 213 (a detecting section) that detects the split light.

The control section 220 includes a light-source control section 221 that carries out control for turning on and off the light source 211 and brightness control while the light source 211 is on, a voltage control section 222 that controls the wavelength variable interference filter 5, a detection control section 223 that controls the image pickup section 213 and acquires a split light image picked up by the image pickup section 213, a signal processing section 224, and a storing section 225.

In the food analyzing apparatus 200, when the system is driven, the light-source control section 221 controls the light source 211. The light source 211 irradiates light on the measurement object. The light reflected by the measurement object is made incident on the wavelength variable interference filter 5 through the image pickup lens 212. A voltage enough for splitting light having predetermined wavelength is applied to the wavelength variable interference filter 5 according to the control by the voltage control section 222. The image pickup section 213 including a CCD camera picks up an image of the split light. The storing section 225 accumulates the picked-up light image as a split-light image. The signal processing section 224 controls the voltage control section 222 to change a voltage value applied to the wavelength variable interference filter 5 and acquires split-light images corresponding to respective wavelengths.

The signal processing section 224 subjects data of pixels in the images accumulated in the storing section 225 to arithmetic processing and calculates spectra in the pixels. In the storing section 225, for example, information concerning ingredients of foods corresponding to spectra is stored. The signal processing section 224 analyzes data of the calculated spectra on the basis of the information concerning foods stored in the storing section 225 and calculates food ingredients included in a detection target and contents of the food ingredients. It is also possible to calculate food calories, freshness, and the like from the calculated food ingredients and contents. Further, it is also possible to carry out, for example, extraction of a portion where freshness is deteriorated in the detection target food by analyzing a spectrum distribution in the images. Moreover, it is also possible to carry out detection of, for example, foreign matters included in the food.

The signal processing section 224 performs processing for causing the display section 230 to display information concerning the ingredients, the contents, the calories, the freshness, and the like of the detection target food obtained as explained above.

In FIG. 15, the example of the food analyzing apparatus 200 is shown. However, with a substantially the same configuration, the electronic apparatus can be used as the noninvasive measuring apparatus for the other information explained above as well. For example, the electronic apparatus can be used as an organism analyzing apparatus that performs an analysis of organism components such as measurement and analysis of body fluid components of blood or the like. As such an organism analyzing apparatus, for example, as an apparatus that measures body fluid components of blood or the like, an apparatus that detects ethyl alcohol can be used as an apparatus for drunken driving prevention that detects a drunken state of a driver. The electronic apparatus can be used as an electronic endoscope system including such an organism analyzing apparatus as well.

Further, the electronic apparatus can be used as a mineral analyzing apparatus that carries out a component analysis for minerals.

Furthermore, as the wavelength variable interference filter, the optical module, and the electronic apparatus in the embodiment of the invention, apparatuses explained below can be applied.

For example, it is also possible to transmit data with lights having respective wavelengths by changing the intensities of the lights having the respective wavelengths over time. In this case, data transmitted by light having specific wavelength can be extracted by splitting the light having the specific wavelength with the wavelength variable interference filter provided in the optical module to cause a light receiving section to receive the light. Optical communication can also be carried out by processing data of the lights having the respective wavelengths using the electronic apparatus including the optical module for data extraction.

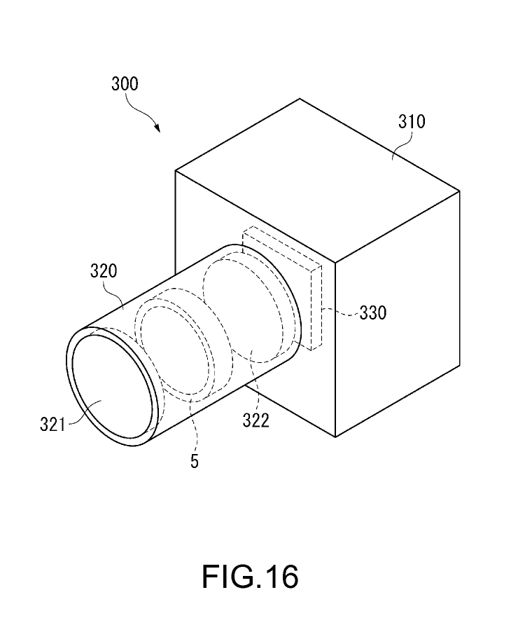

The electronic apparatus can be applied to a spectral camera, a spectral analyzer, and the like that pick up a spectral image by splitting light using the wavelength variable interference filter in the embodiment of the invention. As an example of such a spectrum camera, there is an infrared camera incorporating the wavelength variable interference filter. FIG. 16 is a schematic diagram showing a schematic configuration of the spectral camera. A spectral camera 300 includes, as shown in FIG. 16, a camera main body 310, an image pickup lens unit 320, and an image pickup section 330 (a detecting section).

The camera main body 310 is a portion gripped and operated by a user.

The image pickup lens unit 320 is provided in the camera main body 310. The image pickup lens unit 320 guides incident image light to the image pickup section 330. The image pickup lens unit 320 includes, as shown in FIG. 16, an object lens 321, a focusing lens 322, and the wavelength variable interference filter 5 provided between the lenses.

The image pickup section 330 includes a light receiving element. The image pickup section 330 picks up an image of image light guided by the image pickup lens unit 320.

Such a spectral camera 300 can pick up a spectral image of light having desired wavelength by transmitting light having image pickup target wavelength using the wavelength variable interference filter 5.

Further, the wavelength variable interference filter in the embodiment of the invention may be used as a band-pass filter.

For example, the wavelength variable interference filter can also be used in an optical laser apparatus that splits, with the wavelength variable interference filter, only light in a narrow band having the center in predetermined wavelength among lights in a predetermined wavelength region emitted by the light emitting element and transmits the light.

The wavelength variable interference filter in the embodiment of the invention may also be used in a biometric identification apparatus. For example, the wavelength variable interference filter can be applied as well to an authenticating apparatus for authenticating a blood vessel, a fingerprint, a retina, or an iris using light in a near infrared region or a visible region.

Furthermore, the optical module and the electronic apparatus can be used as a density detecting apparatus. In this case, the density detecting apparatus splits, with the wavelength variable interference filter, infrared energy (infrared light) emitted from a substance, analyzes the infrared energy, and measures a subject density in a sample.

As explained above, the wavelength variable interference filter, the optical module, and the electronic apparatus in the embodiment of the invention can be applied to any apparatus that splits predetermined light from incident light. The wavelength variable interference filter in the embodiment of the invention can split lights having plural wavelengths using one device. Therefore, it is possible to accurately carryout measurement of spectra having plural wavelengths and detection of plural components. Therefore, compared with an apparatus in the past that extracts desired wavelength using plural devices, it is possible to promote a reduction in the sizes of the optical module and the electronic apparatus. The optical module and the electronic apparatus can be suitably used as, for example, portable and vehicle-mounted optical devices.

Besides, specific structure in carrying out the invention can be changed as appropriate to other structures and the like within a range in which the object of the invention can be attained.

The entire disclosure of Japanese Patent Application No. 2011-215597, filed Sep. 29, 2011 is expressly incorporated by reference herein.

What is claimed is:

1. A wavelength variable interference filter comprising:
a first substrate;
a second substrate opposed to the first substrate;
a first reflective film provided on the first substrate, forming a part of a plane and having a fixed area, and configured to reflect a part of incident light and transmit a part of the light;
a second reflective film provided on the second substrate, forming a part of a plane and having a fixed area, configured to reflect a part of incident light and transmit a part of the light, and opposed to the first reflective film via a gap; and
a bonding section configured to bond the first substrate and the second substrate, wherein
the second substrate includes:
a movable section on which the second reflective film is provided;
a holding section provided to surround the movable section in plan view and configured to hold the movable section to be capable of advancing and retracing with respect to the first substrate; and
a substrate outer circumferential section configured to surround an outer circumference of the holding section in the plan view and provided between the holding section and an edge of the second substrate,
the holding section includes:
a flat section having a uniform thickness dimension, which is smaller than thickness dimensions of the movable section and the substrate outer circumferential section, and formed between two planes; and
a holding outer circumferential section provided on an outer side of the flat section in the plan view and formed between a plane and a curved surface, a thickness dimension of the holding outer circumferential section increasing toward the substrate outer circumferential section, and
the bonding section is provided in a circumferential shape in a part of regions opposed to each other of the first substrate and the second substrate in plan view of the first substrate and the second substrate viewed from a substrate thickness direction, and an inner circumferential edge of the bonding section is provided further on an inner side than an outer circumferential edge of the holding outer circumferential section.

2. The wavelength variable interference filter according to claim 1, wherein the inner circumferential edge of the bonding section is provided further on the outer side than an inner circumferential edge of the flat section in the plan view of the first substrate and the second substrate viewed from the substrate thickness direction.

3. The wavelength variable interference filter according to claim 2, wherein the inner circumferential edge of the bonding section is present in a position overlapping the holding outer circumferential section in the plan view of the first substrate and the second substrate viewed from the substrate thickness direction.

4. The wavelength variable interference filter according to claim 3, wherein the inner circumferential edge of the bonding section is present in a boundary position of the flat section and the holding outer circumferential section in the plan view of the first substrate and the second substrate viewed from the substrate thickness direction.

5. The wavelength variable interference filter according to claim 1, wherein
the first substrate include a concave groove section formed on a surface opposed to the second substrate, and
the bonding section is provided over an entire outer circumferential side region of the concave groove section on a surface of the first substrate opposed to the second substrate.

6. An optical filter device comprising:
the wavelength variable interference filter according to claim 1; and
a housing configured to house the wavelength variable interference filter.

7. An optical module comprising:
the wavelength variable interference filter according to claim 1; and
a detecting section configured to detect light extracted by the first reflective film and the second reflective film.

8. An electronic apparatus comprising the wavelength variable interference filter according to claim 1.

9. A method of manufacturing a wavelength variable interference filter including: a first substrate; a second substrate opposed to the first substrate; a first reflective film provided on the first substrate; a second reflective film provided on the second substrate and opposed to the first reflective film via an inter-reflective film gap; and a bonding section configured to bond the first substrate and the second substrate, the second substrate including: a movable section on which the second reflective film is provided; a holding section provided on an outer circumferential side of the movable section in plan view of the second substrate viewed from a substrate thickness direction and configured to hold the movable section to be capable of advancing and retracing with respect to the first substrate; and a substrate outer circumferential section provided on an outer circumferential side of the holding section in the plan view,
the method comprising:
machining the first substrate to form the first reflective film on the first substrate;
machining the second substrate to form the second reflective film on the second substrate; and
bonding the first substrate and the second substrate, wherein
the forming the second reflective film includes forming, with etching, the holding section including: a flat section having a uniform thickness dimension, which is smaller than thickness dimensions of the movable section and the substrate outer circumferential section; and a holding outer circumferential section provided on an outer circumferential side of the flat section in the plan view of the second substrate viewed from the substrate thickness direction, a thickness dimension of the holding outer circumferential section increasing from the flat section toward the substrate outer circumferential section, and an outer circumferential edge of the holding outer circumferential section being located on an outer side of an inner circumferential edge of the bonding section, and
the bonding the first substrate and the second substrate includes performing alignment adjustment to locate the inner circumferential edge of the bonding section further on an inner side than the outer circumferential edge of the holding outer circumferential section in plan view of the first substrate and the second substrate viewed from the substrate thickness direction and then pressurizing and bonding the first substrate and the second substrate via the bonding section.

10. A wavelength variable interference filter comprising:
a first substrate;
a second substrate opposed to the first substrate; and
a bonding section configured to bond the first substrate and the second substrate, wherein
the second substrate includes:
a movable section;
a holding section provided on an outer circumferential side of the movable section in plan view of the second substrate viewed from a substrate thickness direction and configured to hold the movable section to be capable of advancing and retracing with respect to the first substrate; and
a substrate outer circumferential section provided on an outer circumferential side of the holding section in the plan view
the holding section includes:
a flat section having a uniform thickness dimension, which is smaller than thickness dimensions of the movable section and the substrate outer circumferential section; and
a holding outer circumferential section provided on an outer circumferential side of the flat section in the plan view, a thickness dimension of the holding outer circumferential section increasing from the flat section toward the substrate outer circumferential section, and
the bonding section is provided in an outer circumferential region extending along substrate outer circumferential edges on surfaces opposed to each other of the first substrate and the second substrate in plan view of the first substrate and the second substrate viewed from the substrate thickness direction, and an inner circumferential edge of the bonding section is provided further on an inner side than an outer circumferential edge of the holding outer circumferential section.
